(19) United States
(12) Patent Application Publication
(10) Pub. No.: US 2026/0245574 A1
(43) Pub. Date: Aug. 20, 2026

(54) CACHE-BASED STREAMING SPEAKER DIARIZATION

(71) Applicant: NVIDIA Corporation, Santa Clara, CA (US)

(72) Inventors: Ivan Medennikov, Prague (CZ); Taejin Park, San Jose, CA (US); Weiqing Wang, San Jose, CA (US); He Huang, Greenville, SC (US); Kunal Dhawan, San Jose, CA (US); Jinhan Wang, Santa Clara, CA (US); Myungjong Kim, Milpitas, CA (US); Jagadeesh Balam, Saratoga, CA (US); Boris Ginsburg, Sunnyvale, CA (US)

(21) Appl. No.: 19/543,719

(22) Filed: Feb. 18, 2026

Related U.S. Application Data
(60) Provisional application No. 63/760,485, filed on Feb. 19, 2025.

(51) Int. Cl. G10L 21/0308; G10L 17/04; G10L 17/18; G10L 25/18; G10L 25/60; G10L 25/78

(52) U.S. Cl. CPC G10L 21/0308; G10L 17/04; G10L 17/18; G10L 25/18; G10L 25/60; G10L 25/78

(57) ABSTRACT

Disclosed are apparatuses, systems, and techniques for implementing efficient streaming diarization of multi-speaker speech. The techniques include processing, using a trained speaker diarization model, an input that includes (i) one or more digital units (DUs) of a segment of speech and (ii) a speaker cache of one or more previously processed DUs of the speech to obtain a plurality of likelihood values. Each likelihood value characterizes a likelihood that one or more speakers are speaking in the segment of the speech. The speaker cache is mapped to an order of appearance, in the speech, of one or more previously detected speakers. The techniques further include updating the speaker cache using at least the one or more DUs of the segment of the speech and the plurality of likelihood values. The techniques further include generating, using the plurality of likelihood values, a speaker-to-time mapping for the speech.

### RELATED APPLICATIONS

The present application claims priority under 35 U.S.C. § 119(e) to a U.S. Provisional Patent Application No. 63/760,485, entitled “SYSTEMS FOR AND METHODS OF SPEECH DIARIZATION USING ARTIFICIAL INTELLIGENCE MODELS WITH SORTING FUNCTIONALITY,” filed Feb. 19, 2025, whose contents are being incorporated by reference in their entirety herein.

### TECHNICAL FIELD

At least one embodiment pertains to artificial intelligence (AI) resources used to perform and facilitate speech recognition, transcription, and/or diarization. For example, at least one embodiment pertains to systems and techniques that facilitate accurate real-time diarization in streaming speech applications.

### BACKGROUND

Speech recognition, also known as automatic speech recognition (ASR), is an intersection of computer technology and linguistics directed to techniques of recognition and translation of spoken language into text that can be displayed on a screen, output as synthesized speech, printed, stored, used as an input into a conversational model, as an instruction, or in any other way. ASR systems often deploy machine-learning models (MLMs), e.g., trained neural networks, to recognize patterns of speech in a particular language and identify units of speech, such as phonemes, graphemes, words, subwords, sentences, and the like. ASR systems are commonly deployed in user-facing applications, such as virtual agents, live captioning, clinical notetaking, and the like, and can be trained using speech samples produced by multiple speakers to accurately process different language dialects and accents. Automatic speech translation (AST) is a technology that converts words, phrases, and sentences spoken in a first language into the corresponding speech units in a second language. AST can be performed using ASR to transcribe the spoken words into text followed by machine translation of the transcribed text into the second language or by directly converting spoken words to the second language. ASR and AST are parts of the speech-to-text group of technologies. Various speech-to-text systems and techniques can be used alone (e.g., to generate transcriptions and/or other records of speech—such as to synthesize new speech) or in conjunction with various text-to-speech algorithms (e.g., to carry out natural language conversations). Other automatic speech tasks facilitated by machine learning include speaker identification that involves associating spoken utterances with speakers whose speech samples are stored in a database of speakers (or detecting a new speaker not represented in the database), speaker verification that involves determining whether two or more utterances are spoken by the same speaker or different speakers, speaker diarization that includes partitioning unstructured speech among various participants of a conversation or meeting, and/or other tasks. Diarization systems are usually concerned with consistently attributing speech utterances to correct speakers—which can be labeled using any suitable set of labels (e.g., “1”/“2”/“3”/etc. or “A”/“B”/“C”/etc.) —rather focusing on exact speaker identity (e.g., speaker “A” is John Smith), as is the case for speaker identification systems.

### BRIEF DESCRIPTION OF DRAWINGS

FIG. 1 is a block diagram of an example computer system capable of training and deploying streaming diarization models that use speaker cache mapped to an arrival-order of predicted speakers, according to at least one embodiment;

FIG. 2 illustrates an example computing device that supports efficient streaming diarization with speaker cache mapped to an arrival order of predicted speakers, according to at least one embodiment;

FIG. 3 illustrates an architecture of an example diarization system that uses a speaker-mapped cache for accurate streaming diarization of multi-speaker speech, according to at least one embodiment;

FIG. 4 illustrates schematically operations of a diarization model facilitated by the speaker-mapped cache and a cache update function (CUF), according to at least one embodiment;

FIG. 5 illustrates schematically deployment of the speaker-mapped cache and the CUF that may be used to support accurate streaming diarization of multi-speaker speech, according to at least one embodiment;

FIG. 6 is a flow diagram of an example method of training and deployment of a streaming diarization model that performs efficient diarization of multi-speaker speech using speaker-mapped cache, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment;

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure;

FIG. 14 is a block diagram of an example system architecture for an autonomous or semi-autonomous vehicle, robot, and/or other machine type, in accordance with at least some embodiments of the present disclosure; and

FIG. 15 is a system diagram illustrating a three computer ecosystem, including a computing system for generating or creating artificial intelligence (AI) —such as AI training and validation data, a computing system for training artificial intelligence, and a computing system deploying the AI at the edge, in accordance with at least some embodiments of the present disclosure.

### DETAILED DESCRIPTION

The existing diarization models, such as Sortformer models, have achieved high prediction accuracy when processing large speech episodes where individual speakers take multiple turns speaking and, therefore, provide the models with multiple pieces of information and broad context to be relied upon when determining “who spoke when” in those speech episodes. This approach, however, is impractical for streaming applications where audio must be processed incrementally as it becomes available and where low latency is one of important performance metrics. Because diarization is label-agnostic—diarization succeeds provided that any unique set of labels is sufficient for speaker labeling. Since any possible permutation of labels represents an acceptable diarization output (e.g., permutation “A”→“B”→“C”→“A”), offline diarization models are often trained using permutation-invariant learning. Permutation-invariant learning compares the best-fit permutation of the predicted labels to ground truth labels and does not penalize permutations of correct labels. In streaming diarization applications, permutations—while tolerable globally—are not acceptable locally, as each new segment of speech has to be processed in a way that correlates speaker(s) in that segment to previously detected activity of the same speaker(s). As such, permutation invariance in individual segments cannot be allowed in streaming diarization application. A streaming model has to correctly match detected speakers in the newly arrived segments to previously detected speakers. Conventional streaming diarization systems address this problem by forcibly reordering speakers using algorithms like Hungarian linear sum assignment to match earlier-detected speakers with newly arriving speaker data, resulting in complex, computationally expensive code. Handling long audio sessions, e.g., one to two hours, which exceed memory (e.g., GPU memory) capacity represents an additional challenge for streaming diarization systems. Existing streaming diarization techniques do not effectively address the necessity to select appropriate historical speaker context information to accurately detect speaker activity in new segments while also solving the permutation problem.

Aspects and embodiments of the present disclosure address these and other challenges of the diarization technology by providing for techniques and systems that perform efficient and accurate diarization of streaming multi-speaker conversations. More specifically, the disclosed techniques leverage a speaker-mapped cache mechanism that stores speech context data indexed in an order in which various speakers appear in a given speech episode (“the order of arrival” of the speakers). The disclosed models may be trained in multiple stages. A first training stage may be used to train a diarization model to perform offline diarization, and a second training stage may then finetune the pretrained model to learn the streaming functionality. Training may use a hybrid loss function L_{H} that combines a permutation invariant loss function L_{PI} with an arrival-order loss function L_{AO} (also sometimes referred to as “sort” loss function). The permutation-invariant loss function L_{PI} ensures that any permutations of correct ground truth labels are equally acceptable outputs of the diarization model. The arrival-order loss function L_{AO} forces the model to make predictions for each time frame (a given segment may include multiple frames) according to an order in which individual speakers enter the speech episode. For example, the first speaker to speak in the episode is assigned ground truth index k=1, the second is assigned ground truth index k=2, and so on. The model learns to generate a vector of probabilities (for each frame) (P₁, P₂, P₃ . . . P_{N}), the first element of which indicates the probability P₁ that the first speaker speaks during that frame, the second element of which indicates the probability P₂ that the second speaker speaks, and so on. While the permutation-invariant loss does not penalize an incorrect order of the vector elements, e.g., (P₃, P_{N}, P₂, . . . P₁), the arrival-order loss function assigns penalty to such permutations forcing the model to learn to maintain the correct order as the speech episode continues. The hybrid loss function Ly may be a sum of the two loss functions weighted with a suitable weight w, which may be determined empirically, based on trial-and-error testing: L_{H}=w·L_{AO}+(1−w)·L_{PI}. This learned arrival-time ordering is also used during streaming inference, eliminating the need for auxiliary algorithms to select a correct permutation.

In the second—streaming fine-tuning—stage and in inference, the diarization model processes audio segments using a sliding window approach. The sliding window includes a current (e.g., multi-frame) segment of a predetermined duration and a historical portion of previously processed segments and/or frames. For example, the model may maintain a FIFO (first-in-first-out) queue of recently processed frames (or embeddings corresponding to such frames) to maintain local context of the speech episode. Additionally, processed frames may be added to the speaker-mapped cache to maintain global context (history) of the speech episode. Initially, when the speaker-mapped cache is empty or partially filled, all historical frames may be placed in the speaker-mapped cache. Later, when the number of processed frames exceeds the speaker-mapped cache's capacity, the system may compress the historical context, e.g., by keeping in the speaker-mapped cache the frames and/or embeddings for which speaker activity has been identified with the highest confidence (amounting to the best samples of speakers' speech activity). In some embodiments, equal number of frames/embeddings may be allocated to each speaker. In some embodiments, a minimum number of frames/embeddings may be allocated to individual speakers (to prevent speakers from disappearing from the speaker-mapped cache) with the remaining space—shared pool—in the speaker-mapped cache allocated to high-confidence frames/embeddings regardless of the speaker. The speaker-mapped cache may be indexed in the order of speaker arrival in the speech episode. In some embodiments, speaker-associated frames/embeddings in the speaker-mapped cache may be spaced by one or more spacer frames/embeddings detected to correspond to silence, when no speaker is active. This helps the model with distinguishing between different speakers.

The speaker-mapped cache may be updated using a confidence-based scoring system that selects most representative frames/embeddings for various speakers. Frames/embeddings corresponding to overlapping speech (multiple speakers co-speaking at the same time) may receive lower importance scores, serving as protection against including ambiguous/low-quality frames in the speaker-mapped cache. As part of a given speech segment processing, the model may process (i) the segment, (ii) the queue of previously processed frames/embeddings, and (iii) the speaker-mapped cache to generate predictions for the segments. As a result, the diarization model automatically produces correctly ordered predictions without relying on any post-hoc permutation matching.

The advantages of the disclosed techniques include, but are not limited to, efficient resolution of the permutation problem through arrival-time-ordered predictions and elimination of the need for complex speaker-matching algorithms in streaming speech applications. This results in simpler, faster, and more accurate processing with reduced computational overhead. The confidence-based cache update mechanism effectively compresses long audio sessions into fixed-size speaker representations while preserving the most informative data for each speaker. The system is well-suited for real-time applications such as voice agents, streaming transcription, sports commentary, closed captioning, and/or the like where multiple speakers are present, thus providing flexibility for integration with existing speech processing systems.

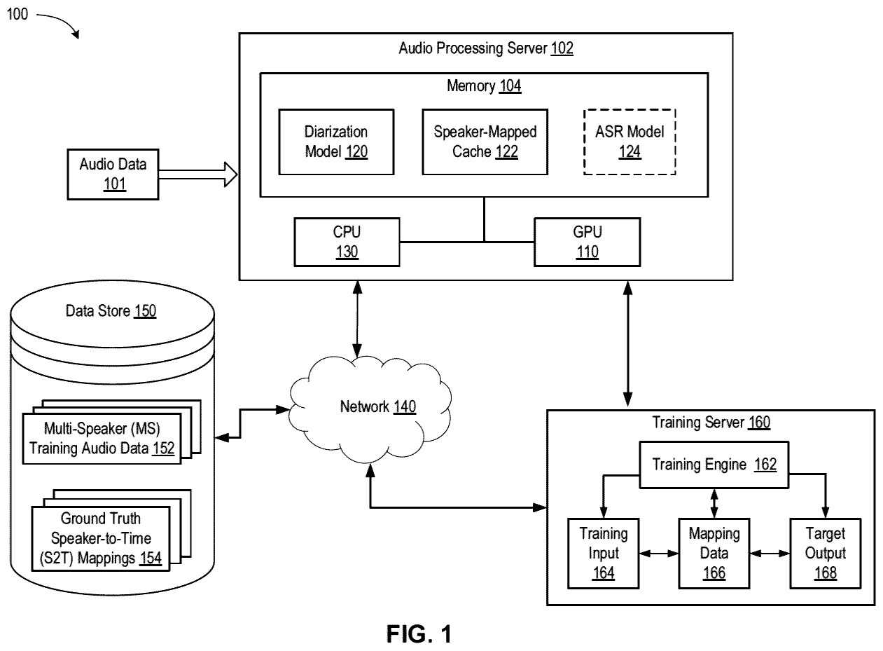

FIG. 1 is a block diagram of an example computer system 100 capable of training and deploying streaming diarization models that use speaker cache mapped to an arrival-order of predicted speakers, according to at least one embodiment. As depicted in FIG. 1, a computing system 100 may include an audio processing server 102, a data store 150, and a training server 160 connected to a network 140. Network 140 may be a public network (e.g., the Internet), a private network (e.g., a local area network (LAN), or wide area network (WAN)), a wireless network, a personal area network (PAN), a combination thereof, and/or another network type.

Audio processing server 102 may include a desktop computer, a laptop computer, a smartphone, a tablet computer, a server, a wearable device, a VR/AR/MR headset or head-up display, a digital avatar or chatbot kiosk, an in-vehicle infotainment computing device, and/or any suitable computing device capable of performing the techniques described herein. Audio processing server 102 may be configured to receive audio data 101 that may be associated with any speech episode involving multiple speakers. Speech episodes may include a public or private conversation, a business meeting, a public or private presentation, an artistic event, a debate, an interaction between a digital agent (e.g., chat bot, digital avatar, etc.) and one or more users, an in-vehicle communication (e.g., between two or more occupants, between an occupant(s) and a chat bot, avatar, or digital assistant of the vehicle), and/or the like. Audio data 101 may be recorded using one or more devices connected to audio processing server 102, retrieved from memory 104 of audio processing server 102, and/or received over any local or network connection (e.g., via network 140) from an external computing device. Audio data 101 may be in any suitable format, e.g., WAV, AIFF, MP3, AAC, WMA, or any other compressed or uncompressed audio format. In some embodiments, audio data 101 may be stored (e.g., together with other data, such as metadata) in data store 150. Additionally, data store 150 may store multi-speaker training audio data 152 for training one or more machine learning models, e.g., Diarization model 120. Data store 150 may be accessed by audio processing server 102 directly or (as shown in FIG. 1) via network 140.

Data store 150 may include a persistent storage device capable of storing audio files as well as metadata for the stored audio files. Data store 150 may be hosted by one or more storage devices, such as main memory, magnetic or optical storage disks, tapes, or hard drives, network-attached storage (NAS), storage area network (SAN), and so forth. Although depicted as separate from audio processing server 102, in at least some embodiments, data store 150 may be a part of audio processing server 102. In at least some embodiments, data store 150 may be a network-attached file server, while in other embodiments, data store 150 may be some other type of persistent storage such as an object-oriented database, a relational database, and so forth, that may be hosted by a server machine or one or more different machines coupled to the audio processing server 102 via network 140.

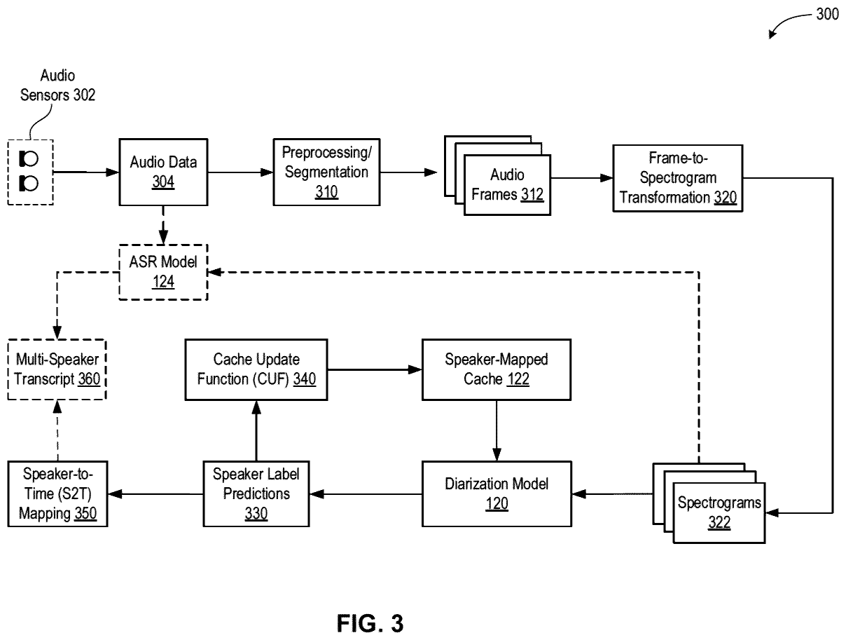

Audio processing server 102 may include memory 104 (e.g., one or more memory devices or units) communicatively coupled with one or more processing devices, such as one or more graphics processing units (GPU) 110, one or more central processing units (CPU) 130, one or more data processing units (DPU), one or more parallel processing units (PPUs), and/or other processing devices, such as field-programmable gate arrays (FPGAs), application-specific integrated circuits (ASICs), and/or the like. Memory 104 may store one or more components and models, such as diarization model 120 to generate speaker-to-time (S2T) mappings indicating when various speakers in a speech episode represented in audio data 101 are speaking, e.g., [00:00-00:04; Speaker 1] [00:03-00:11; Speaker 2] [00:13-00:19; Speaker 3] [00:17-00:25; Speaker 2], and so on. Operations of diarization model 120 may be facilitated by a speaker-mapped cache 122 that facilitates ordering (or some other indexing or mapping) of predicted speakers, e.g., chronologically as respective speaker appear (speak for the first time) in the speech episode, as disclosed in more detail in conjunction with FIGS. 3-6. In some embodiments, audio processing server 102 may deploy various additional models and/or systems, e.g., audio speech recognition (ASR) model 124 capable of outputting a transcription of audio data 101, e.g., word-by-word spoken content. The outputs of diarization model 120 and ASR model 124 may be combined to obtain a time-mapped transcription of audio data 101 predicting both the content (what was spoken) and the S2T mapping (who spoke when). In some embodiments, a speaker or voice identification model may be deployed by audio processing server 102 (not shown in FIG. 1) to determine identity of the speakers.

In at least one embodiment, diarization model 120 may be implemented as a deep learning neural network having multiple levels of linear or non-linear operations. For example, diarization model 120 may include convolutional neural networks, recurrent neural networks, fully-connected neural networks, long short-term memory (LSTM) neural networks, neural networks with attention, e.g., transformer neural networks, and/or the like, or some combination thereof, e.g., conformer neural networks (a combination of convolutional networks and transformer neural networks). In at least one embodiment, diarization model 120 may include multiple neurons, an individual neuron receiving its input from other neurons and/or from an external source and producing an output by applying an activation function to the sum of inputs modified by (trainable) weights and a bias value. In at least one embodiment, diarization model 120 may include multiple neurons arranged in layers, including an input layer, one or more hidden layers, and/or an output layer. Neurons from adjacent layers may be connected by weighted edges. In some embodiments, training server 160 may train a number of different models, which may be models that differ by a number of neurons, number of neuron layers, specific neural architecture, and/or the like.

Diarization model 120 may be trained to process multi-speaker training audio data 152 and generate S2T mapping for speech recorded in the multi-speaker training audio data 152. The outputs of diarization model 120 also include detection of utterances of more than one speaker speaking at the same time. Multi-speaker training audio data 152 may be stored in data store 150 in a raw audio format, e.g., in the form of spectrograms, or in any other suitable representation characterizing speech. A spectrogram of multi-speaker training audio data 152 may be obtained by recording air pressure caused by the speech as a function of time and computing a short-time Fourier transform for overlapping time intervals (frames) of a set duration. This maps the audio signal from the time domain to the frequency domain and generates a spectrogram characterizing the spectral content of multi-speaker training audio data 152. The amplitude of the audio signal may be represented on a logarithmic (decibel) scale. In some embodiments, the obtained spectrograms may be further converted into mel-spectrograms, by transforming frequency f into a non-linear mel domain, f→m=a ln(1+f/b), to take into account the ability of a human ear to better distinguish between equally spaced frequencies (tones) at the lower end of the frequencies of the audible spectrum than at its higher end. In one example, a=1607 and b=700 Hz. Throughout this disclosure, the term “spectrogram” may be understood to include Fourier spectrograms, mel-spectrograms, wavelet spectrograms, time-domain filterbanks, custom filterbanks, learnable filterbanks, custom audio embeddings, and/or other forms of analog or digital intermediate audio representation, or some combination thereof.

Multi-speaker training audio data 152 may be used by a training server 160 to identify parameters (e.g., neural weights, biases, parameters of activation functions, etc.) of diarization model 120 that maximize success of speech transcriptions. Training server 160 may be hosted by a desktop computer, a laptop computer, a smartphone, a tablet computer, a server, and/or any suitable computing device capable of performing the techniques described herein. In some embodiments, training of diarization model 120 may be supervised, e.g., using human-generated or machine-generated ground truth S2T mappings 154, which identify correct intervals of time when various speakers are speaking, including correct order of arrival (first time spoken by various speakers). In some embodiments, training may be unsupervised, semi-supervised, and/or include reinforcement learning techniques.

Multi-speaker training audio data 152 may be used by training engine 162 as training input 164 to train diarization model 120 to generate training outputs. In some embodiments, training engine 162 may cause diarization model 120 to process training inputs 164 constructed using multi-speaker training audio data 152, which may include various recorded speech utterances, including overlapping utterances. During training, training engine 162 may also generate mapping data 166 (e.g., metadata) that associates training inputs 164 with correct target outputs 168 (ground truth). Training may cause diarization model 120 to identify patterns in training inputs 164 based on desired target outputs 168 and learn to accurately identify various spoken phonemes, words, etc., spoken by various speakers in training inputs 164.

Initially, edge weights and biases (e.g., parameters) of various network models being trained may be assigned some starting (e.g., random) values. For every training input 164, training engine 162 may cause diarization model 120 to generate output(s). Training engine 162 may then compare observed output(s) with the desired target output(s) 168. The resulting error or mismatch, e.g., the difference between the desired target output(s) 168 and the actual output(s) of the neural networks, may be back-propagated through the respective neural networks, and the weights and biases in the neural networks may be adjusted to make the actual outputs closer to the target (ground truth) outputs. This adjustment may be repeated until the output error for a given training input 164 satisfies a predetermined condition (e.g., falls below a predetermined value). Subsequently, a different training input 164 may be selected, a new output generated, and a new series of adjustments implemented, until the respective neural networks are trained to a target degree of accuracy or until the neural network(s) converges to a limit of its architecture-determined accuracy.

Predictive utility of the identified patterns may be subsequently verified using additional training input/target output associations. The trained diarization model 120 and/or other models similarly trained, may be used, during the inference stage, for processing of new (not encountered in training) input speech.

In at least one embodiment, training server 160 and audio processing server 102 may be implemented on a single computing device. Training server 160 and/or audio processing server 102 may be (and/or include) a rackmount server, a router computer, a personal computer, a laptop computer, a tablet computer, a desktop computer, a media center, or any combination thereof.

In some embodiments, for efficient training, dropout techniques may be used for at least some of the training epochs, with outputs of at least some neurons removed (e.g., replaced with zero outputs). This forces the remaining neurons to learn how to perform diarization tasks more efficiently and generate more accurate outputs. In the course of training, different neurons (e.g., randomly chosen neurons) may be dropped during processing of different batches of training data, so that all neurons learn to perform tasks more accurately and efficiently.

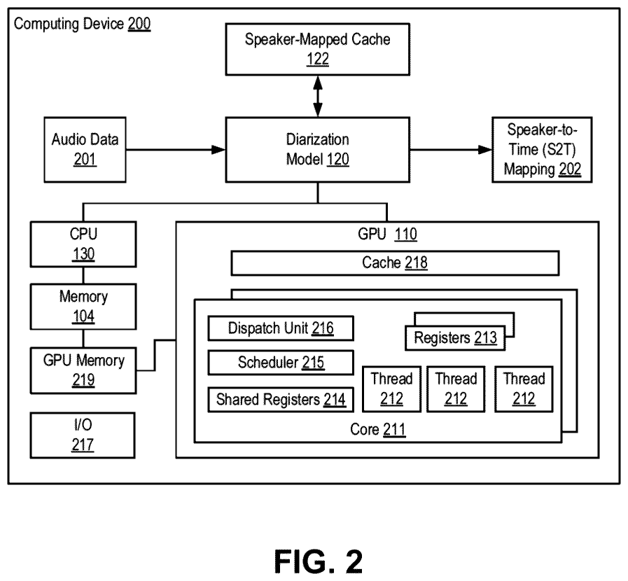

FIG. 2 illustrates an example computing device 200 that supports efficient streaming diarization with speaker cache mapped to an arrival order of predicted speakers, according to at least one embodiment. In at least one embodiment, computing device 200 may be a part of computing system 100 (with reference to FIG. 1). In at least one embodiment, computing device 200 may be a part of audio processing server 102. In at least one embodiment, computing device 200 may be a part of training server 160. In at least one embodiment, computing device 200 may support diarization model 120 that processes audio data 201 and generates an S2T mapping 202 of multi-speaker speech captured in the audio data 201. As illustrated, diarization model 120 may use speaker-mapped cache 122 that facilitates alignment of predicted speakers to an order of their appearance in audio data 201.

Operations of various modules instantiated on computing device 200 may be executed using one or more GPUs 110, one or more CPUs 130, one or more parallel processing units (PPUs) or accelerators, such as a deep learning accelerator, data processing units (DPUs), and/or the like. In at least one embodiment, a GPU 110 includes multiple cores 211, each core being capable of executing multiple threads 212. Each core may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of the core. In at least one embodiment, each core 211 may include a scheduler 215 to distribute computational tasks and processes among different threads 212 of core 211. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 110 may have a (high-speed) GPU cache 218, access to which may be shared by multiple cores 211. Furthermore, computing device 200 may include a GPU memory 219 where GPU 110 may store intermediate and/or final results (outputs) of various computations performed by GPU 110. After completion of a particular task, GPU 110 (or CPU 130) may move the output to (main) memory 104. In at least one embodiment, CPU 130 may execute processes that involve serial computational tasks whereas GPU 110 may execute tasks (such as multiplication of inputs of a neural node by weights and adding biases) that are amenable to parallel processing.

FIG. 3 illustrates an architecture 300 of an example diarization system that uses a speaker-mapped cache for accurate streaming diarization of multi-speaker speech, according to at least one embodiment. In at least one embodiment, the diarization system illustrated in FIG. 3 may include diarization model 120, which may be a part of an audio processing server 102 illustrated in FIG. 1. Various blocks in FIG. 3 denoted with the same numerals as the respective blocks of FIG. 1 and FIG. 2 may implement the same (or a similar) functionality.

As illustrated in FIG. 3, the diarization system may receive audio data 304 captured by one or more audio sensors 302, e.g., microphones. Microphones may include dynamic microphones, condenser microphones, ribbon microphones, unidirectional microphones, omnidirectional microphones, and/or any other types of microphones. In some embodiments, a microphone can be combined with other devices, e.g., computers, phones, speakers, TV screens, and/or the like. Audio data 304 collected by audio sensors 302 may be produced, e.g., spoken, by multiple speakers and may include a single speech episode or multiple speech episodes. Audio data 304 may include one or more overlapping utterances. Audio sensors 302 may capture not only a speech signal but also background noise, interference signals, e.g., emitted by TV devices, radio devices, alarm devices, and/or any other equipment, or sounds naturally occurring (e.g., sound of wind, water, birds, etc.).

Audio data 304 collected by audio sensors 302 may undergo speech preprocessing and segmentation 310. For example, preprocessing may include audio filtering, denoising, amplification, dereverberation, and/or any other suitable enhancement. Preprocessing may further include removal of portions of the audio data 304 that do not have a speech content. For example, preprocessing may evaluate energy e(t) associated with the audio data as a function of time and identify regions that have energy less than a certain threshold (e.g., an empirically determined noise threshold). Such identified regions may be removed (trimmed) from the audio data 304 during speech preprocessing. Segmentation may include segmenting audio data 304 into segments of predetermined sizes (durations), τ, e.g., 0.5-5 sec. A segment may but need not correspond to a complete logical unit of speech and may encompass one or more sentences, one or more words, a part of a word (e.g., subwords), one or more exclamations or other punctuation, filler words, pauses, and/or the like. In some embodiments, the segments may be partially overlapping.

In some embodiments, the audio data 304 is converted to log-mel spectrograms prior to processing by the diarization model 120. In at least one embodiment, the conversion includes: performing a short-time Fourier transform (STFT) using a window size of 20-40 milliseconds and a hop length of 5-15 milliseconds; applying a window function (e.g., Hann or Hamming) to each frame; computing the magnitude spectrum; projecting the magnitude onto a Mel filterbank comprising 40-128 triangular filters spanning the frequency range from 20 Hz to 8,000 Hz; and applying logarithmic compression according to the formula log (1+C·|X|) where X represents the Mel-filtered magnitude and C is a compression constant (e.g., 50-200). The resulting log-Mel spectrograms can be normalized per-utterance to zero mean and unit variance using statistics computed over the entire speech episode. This preprocessing protocol yields input features that are robust to amplitude variations and optimized for the processing by diarization model 120. In some embodiments, diarization model 120 is trained on identically preprocessed multi-speaker training audio data 152 (with reference to FIG. 1). The use of log-Mel spectrograms as the primary input representation improves the accuracy of diarization compared to linear spectrograms, particularly in noisy multi-speaker environments.

Individual segments may be represented by a plurality of audio frames 312, e.g., M frames over a certain predetermined interval of time. Audio frames 312 may have a duration of 10 msec, 15 msec, 20 msec, 30 msec, and/or some other duration. Audio frames 312 may undergo a suitable frame-to-spectrogram transformation 320. For example, a spectrogram of a frame may be obtained or generated by performing the discrete Fourier transform of acoustic energy e(t) or air pressure p(t) associated with a specific utterance. The obtained spectrograms e(fⱼ) may be defined for a number of bands f₁, f₂ . . . f_{c}, for example, for C=80 bands or C=128 bands, or any other number of bands. Throughout this disclosure, the term “spectrogram” may be understood to include Fourier spectrograms, mel-spectrograms, wavelet spectrograms, time-domain filterbanks, custom filterbanks, learnable filterbanks, custom audio embeddings, and/or other forms of analog or digital intermediate audio representation, or some combination thereof. Separate spectrograms 322 may be obtained for separate audio frames 312.

In some embodiments, spectrograms 322 may be processed by diarization model 120 that outputs time-mapped speech activity of various speakers. As additional speakers are detected in audio data 304 (e.g., as a speech episode captured by audio data 304 unfolds), speech data associated with the detected speakers is placed in speaker-mapped cache 122 and used for detection of utterances of these speakers at later times of the speech episode. In some embodiments, diarization model 120 may be trained to detect up to a certain number Nₘₐₓ of channels corresponding to speech activity of various speakers in the input speech. In other embodiments, diarization model 120 may be trained to have a dynamic number Nₘₐₓ. For example, as additional speakers are detected, the portion of speaker-mapped cache 122 allocated to an individual speaker may be decreased, so that all speakers are represented in the cache.

Diarization model 120 may convert spectrograms 322 into suitable embeddings that represent (“embed”) voice/speech characteristics of a speaker in the embedding space of some dimension D (a number of components in an embedding), which may be set as part of architecture of diarization model 120. Individual components of embeddings may have integer values or floating-point values. Embeddings may be considered as points in the D-dimensional embedding space. During training, diarization model 120 (or a portion of the model, e.g., a pre-encoder network) may learn to associate similar sets of training spectrograms with similar embeddings corresponding to points closely situated in the embedding space and further learn to associate dissimilar sets of training audio data with points that are located farther apart in the embedding space.

Diarization model 120 may use embeddings to identify similarly sounding portions of audio data 304 and associate those portions with speaking activity of respective speakers by outputting speaker label predictions 330. Speaker label predictions 330 may then be used as an input into a cache update function (CUF) 340 that updates speaker-mapped cache 122. For example, CUF 340 may assign quality scores to newly processed units of audio data 304 (represented via corresponding embeddings) and compare these quality scores with scores of previously processed units and already represented in speaker-mapped cache 122. The units (or digital units) herein should be broadly understood as any quantized representation of an acoustic signal, including but not limited to raw audio samples, individual frames, spectrograms of those frames, groups of frames/spectrograms, multi-modal tokens, or embeddings (e.g., convolutional, attention-based, or self-attention-based) representing such signals or portions thereof. If the newly processed units have quality scores that are higher than the quality scores of units stored in speaker-mapped cache 122, some of the units in the speaker-mapped cache 122 may be replaced with the higher-scored new units. In some embodiments, newly processed units may be favored (e.g., by an addition of a bias term to their scores) over units already stored in the speaker-mapped cache 122. As a result, units of increasingly improved quality are being stored in speaker-mapped cache 122. If a new speaker is detected entering the speech episode, speech data for this new speaker receives representation in speaker-mapped cache 122, which is then improved with detection of subsequent utterances of the speaker.

In some embodiments, a digital unit comprises a speaker-specific signature extracted from an audio stream at any level of a neural network hierarchy. For example, in some embodiments a digital unit includes low-level features (e.g., raw waveforms or short-time Fourier transforms), intermediate-level features (e.g., log-mel filterbanks or convolutional layers lacking attention), or high-level semantic features (e.g., contextual embeddings from a Transformer or Large Language Model). Furthermore, a digital unit in some embodiments represents a fixed-duration segment (e.g., 80 ms) or a variable-duration acoustic event, and can be derived from human speech, robotic/synthesized speech, or environmental acoustic phenomena.

Speaker label predictions 330 output by diarization model 120 may be used to generate a speaker-to-time (S2T) mapping 350 of speaker labels (e.g., “1”/“2”/etc.) to time intervals where detected speakers are active. In some embodiments, e.g., as illustrated with dashed blocks and arrows in FIG. 3, S2T mapping 350 may be used together with an output of a suitable ASR model 124 (which may process the same audio data 304 or spectrograms 322) to generate a time-mapped multi-speaker transcript 360.

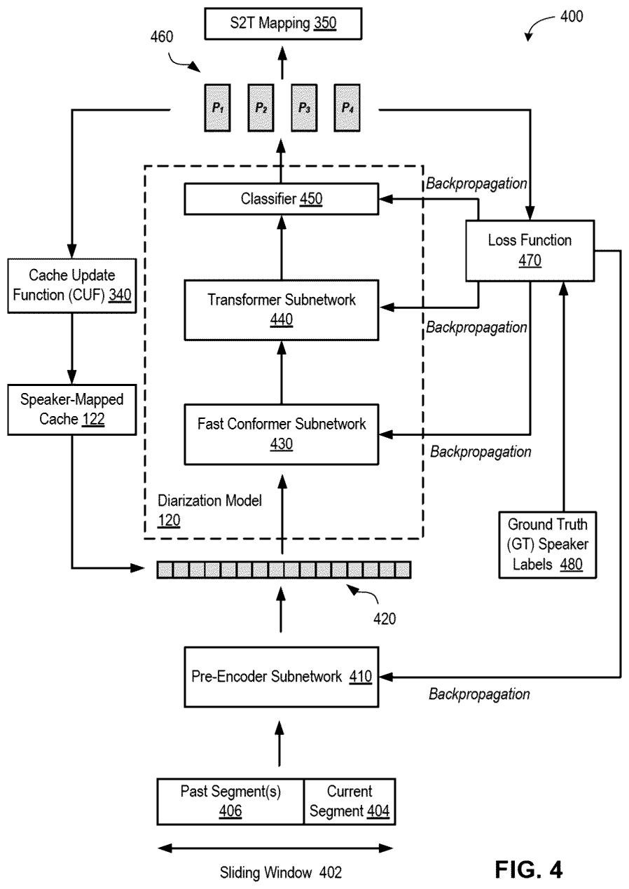

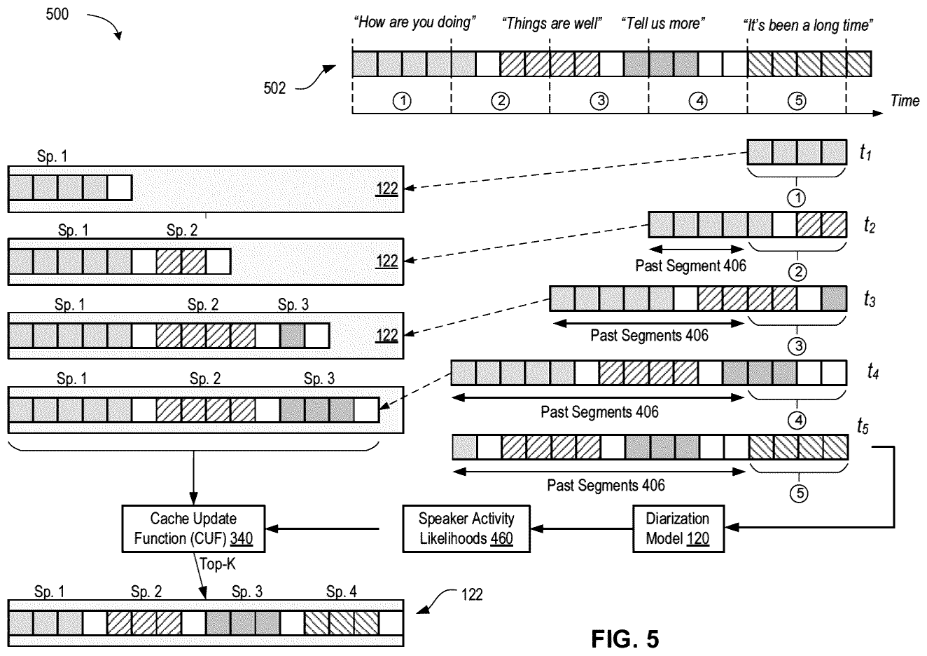

FIG. 4 illustrates schematically operations 400 of a diarization model facilitated by a speaker-mapped cache and a cache update function (CUF), according to at least one embodiment. As illustrated, a sliding window 402 that includes a certain number of frames or spectrograms (e.g., spectrograms 322) of audio data may be used as an input into diarization model 120 for a given time step t₁, t₂, . . . tⱼ of the audio data processing. Sliding window 402 for timestep tⱼ may include a current segment 404, which may include frames/spectrograms of the combined duration Δt=tⱼ−tⱼ₋₁ of the audio data received since the last time step tⱼ₋₁. Additionally, sliding window 402 may include one or more past (earlier processed) segments 406, e.g., segments processed as part of timestamps tⱼ₋ₘ . . . tⱼ₋₁. The number of past segments m may be an integer number, but this is not a requirement, and any number of spectrograms may be included in the past segment(s) 406, including any non-integer number of segments (e.g., 2.5 segments, 10.4 segments, and/or the like). Sliding window 402 may be processed by a pre-encoder subnetwork 410, which may generate embeddings 420 corresponding to individual frames/spectrograms or groups of frame/spectrograms. (Individual embeddings are illustrated schematically with squares in FIG. 4 and FIG. 5.)

In some embodiments, pre-encoder subnetwork 410 may include one or more convolutional neuron layers. In some embodiments, pre-encoder subnetwork 410 may perform downsampling of spectrograms of sliding window 402, e.g., downsampling from 10-msec spectrograms to 80-msec embeddings 420. In such embodiments, individual embeddings 420 may correspond to multiple spectrograms of sliding window 402. In some embodiments, no downsampling is performed, and individual embeddings 420 correspond to individual spectrograms. In some embodiments, pre-encoder subnetwork 410 may perform upsampling, such that multiple embeddings 420 correspond to each individual spectrogram of the sliding window 402. In some embodiments, pre-encoder subnetwork 410 may include a multilayer perceptron network (not shown in FIG. 4 for brevity).

At least some of the embeddings 420 may be retrieved from speaker-mapped cache 122, as disclosed in more detail in conjunction with FIG. 5. Although FIG. 4 illustrates that pre-encoder subnetwork 410 processes both the spectrograms of the current segment 404 and of the past segment(s) 406, the diarization system may take advantage of previously processed segments and just process the current segment 404 through pre-encoder subnetwork 410 while aggregating embeddings 420 for the past segment(s) 406 with the embeddings for the current segment 404 produced by pre-encoder subnetwork 410. To facilitate this, a buffer, e.g., a FIFO buffer, of a predetermined size may be used to store the embeddings for the past segment(s) 406. Once the embeddings of current segment 404 are processed by diarization model 120, a copy of these embeddings may be placed in the FIFO buffer causing displacement of the oldest segment from the FIFO buffer. The content of the FIFO buffer may then be used as an input into diarization model 120 when the next segment is being processed.

Diarization model 120 may include a number of subnetworks, e.g., one or more fast conformer subnetwork 430, one or more transformer subnetworks 440, and/or other subnetworks, e.g., multilayer perceptron networks. (One subnetwork of each type is shown in FIG. 4 for conciseness.) Conformer subnetwork(s) 430 may include one or more conformer blocks. A conformer block combines a transformer block, which implements an attention mechanism for the inputs with a block of convolutions trained to capture an expanding field of view along the channel dimension while simultaneously increasing the feature space dimension. In some embodiments, the convolutions of conformer blocks may be factorized into depthwise convolutions (convolutions along the feature dimensions) and pointwise convolutions (convolutions along the channel dimensions). In some embodiments, each conformer block may further deploy one or more fully connected layers. In some embodiments, each conformer block may include various additional mechanisms, including but not limited to residual (skip) connections, one or more squeeze-and-excitation blocks, and/or the like.

Diarization model 120 may process embeddings 420 through fast conformer subnetwork(s) 430, transformer subnetwork(s) 440, etc., to produce hidden features representative of current segment 404 while also accounting for the context provided by past segment(s) 406 and speaker-mapped cache 122. The hidden features may then be processed by a classifier 450, which may include one or more layers (e.g., fully connected layers) and a classifier function, such as a sigmoid function (although other classifier functions, such as softmax function, may be used in some embodiments). Classifier 450 may generate speaker activity likelihoods 460, which may include probabilities P₁, P₂, . . . P_{N} that respective speakers 1, 2, . . . N are active within a certain internal of times. Such intervals may match duration of speech associated with individual embeddings. For example, if individual embeddings 420 correspond to 80 msec intervals (e.g., 8 downsampled spectrograms of 10 msec duration), the set of probabilities P₁, P₂, . . . P_{N} may be generated for each 80 msec of the input audio. In some embodiments, one set of probabilities P₁, P₂, . . . P_{N} may be produced per multiple embeddings 420. Probabilities P₁, P₂, . . . P_{N} need not be normalized (e.g., ΣᵢPᵢ≠1) since speech activity of multiple speakers need not be mutually exclusive and may occur simultaneously.

Speaker activity likelihoods 460 may be used to generate S2T mapping 350 of the speech episode that is being diarized. In some embodiments, each of the speaker activity likelihoods 460 may be compared to a threshold likelihood. For example, a threshold probability P₀ may be defined with probabilities Pₖ that are smaller than P₀ (Pₖ<P₀) determined to correspond to portions of the speech that have no speech activity of speaker k. In some embodiments, the threshold probability may be P₀=0.5, 0.6, or some other empirical value. Portions of speech associated with Pₖ≥P₀ may be determined to have positive speech activity of speaker k, which is then included in S2T mapping 350.

Speaker activity likelihoods 460 may also be used as an input into cache update function (CUF) 340 that performs update of speaker-mapped cache 122, as disclosed in more detail in conjunction with FIG. 5.

Training of diarization model 120 may be performed using training speech episodes that contain speech of multiple speakers. In some embodiments, operations of blocks 470 and 480 in FIG. 4 may be performed during training and not performed during inference. In some embodiments, training speech inputs may include synthetic speech, e.g., generated by one or more trained text-to-speech models.

In some embodiments, training may be performed in stages. During the first stage, diarization model 120 may be trained as an offline model, e.g., using long speech episodes (such as 10-20 minutes long or even more). During the second stage, diarization model 120 may be finetuned using streaming speech episodes, e.g., speech previously unseen by the model.

Speaker activity likelihoods 460 predicted by diarization model 120 may be compared, using a suitable loss function 470, to ground truth speaker labels 480 for various times (e.g., timestamps) of the training speech. In some embodiments, loss function 470 may compare a predicted probability Pₖ that a given speaker speaks during a particular interval of the training speech to a ground truth label yₖ. The ground truth label may assume value 0 indicative of speaker k being silent or value 1 indicative of speaker k speaking during the interval. The predicted probability Pₖ may be a continuous output within the interval [0, 1] with the value 0 corresponding to full confidence in the prediction that speaker k is silent and value 1 corresponding to full confidence that speaker k is active.

Loss function 470 may deploy a binary cross-entropy loss function L_{BCE}:

$${L}_{BCE} = - {y}_{k} log {P}_{k} - ( 1 - {y}_{k} ) log ( 1 - {P}_{k} ) .$$

This loss function has value L_{BCE}=0 if the predicted probability Pₖ is equal to the ground truth label, value L_{BCE}=log 2 if the predicted probability Pₖ=1/2 (a “toss-up” prediction) and value L_{BCE}=+∞ if the model predicts the wrong label with full confidence.

In some embodiments, loss function 470 may be a hybrid loss function L_{H} that combines a permutation invariant loss function L_{PI} with an arrival-order loss function L_{AO}. The permutation-invariant loss function L_{PI} ensures that any permutations of correct ground truth labels are equally acceptable outputs of the diarization model, e.g., L_{PI}=min ΣL_{BCE} (perm), where the sum is taken over predictions for all speakers k and all possible permutations of the speakers, as indicates schematically with (perm). The arrival-order loss function L_{AO} may similarly be a sum of binary cross-entropy loss functions where ground truth labels y₁ . . . y_{N} correspond to the correct order of arrival of the speakers (e.g., with the earliest-starting speaker assigned label y₁ and the latest-starting speaker assigned label y_{N}). The hybrid loss function may be a weighted sum of both loss functions, L_{H}=w·L_{AO}+(1−w)·L_{PI}, taken with a suitable weight w, e.g., w=0.5, 0.4, 0.7, and/or the like, the weight w to be determined empirically, based on experimentation.

The values computed using loss function 470 may be used to modify various networks of diarization model 120, e.g., fast conformer subnetwork(s) 430, transformer subnetwork 440, classifier 450, and/or other trainable networks, such as pre-encoder subnetwork 410, in a way that reduces the value of the computed loss function 470. This modification may be performed using backpropagation, gradient descent, and/or other learning techniques.

FIG. 5 illustrates schematically deployment 500 of a speaker-mapped cache and a cache update function (CUF) that may be used to support accurate streaming diarization of multi-speaker speech, according to at least one embodiment. As illustrated, an audio of a four-speaker conversation 502 is being processed: “Speaker 1: How are you doing?”; “Speaker 2: Things are well”; “Speaker 3: Tell us more”; “Speaker 4: It's been a long time” . . . . The conversation 502 is represented via embeddings (depicted as squares), e.g., by pre-encoder subnetwork 410 with reference to FIG. 4. Embeddings depicted with squares of different shadings correspond to different speakers. The embeddings are grouped into segments (enumerated with circled numbers), with four embeddings per segment, which are then processed sequentially, in conjunction with the corresponding time steps t₁, t₂, . . . tⱼ.

At first step t₁, no history exists and the first segment \textcircled{1} is processed without context. The processed first segment is determined to be associated with Speaker 1 (e.g., as disclosed in conjunction with FIG. 1) and stored in speaker-mapped cache 122. Since speaker-mapped cache 122 is initially empty, the entire first segment may be stored therein. Additionally, the first segment may be placed in the FIFO buffer of the processed segments (not shown in FIG. 5 for conciseness).

At second step t₂, the second segment \textcircled{2} is processed (e.g., concatenated) together with the context that includes the past segment 406 (e.g., stored in a FIFO buffer) and the current speaker-mapped cache 122. Embeddings of the second segment determined to be associated with Speaker 1 (indicated with light grey shading) are added to the embeddings of Speaker 1 previously stored in speaker-mapped cache 122. Embeddings determined to be associated with Speaker 2 (indicated with cross-hatched shading) may be stored in speaker-mapped cache 122 separated from Speaker 1 embeddings with one or more spacer embeddings (shown as white square) detected to be associated with silence (no speech activity of any speaker). Since speaker-mapped cache 122 is not filled yet, all new embeddings may be added to the cache. (speaker-mapped cache 122 in the illustrated non-limiting example has the maximum size of 16 embeddings.)

At third step t₃, the third segment \textcircled{3} is processed together with the context that includes the past segments 406 (which now includes both the first segment and the second segment) and the current speaker-mapped cache 122. Embeddings of the third segment determined to be associated with Speaker 2 are added to the embeddings of Speaker 2 previously stored in speaker-mapped cache 122. An embeddings determined to be associated with Speaker 3 (indicated with dark grey shading) may be stored in speaker-mapped cache 122, being separated from Speaker 2 embeddings with one or more spacer embeddings. Since speaker-mapped cache 122 is not filled yet, all new embeddings may still be added to the cache.

As illustrated with these examples, speaker-mapped cache 122 is indexed in the order of speaker arrival in the speech episode, with embeddings associated with the earlier-arrived speakers located to the left of embeddings associated with the later-arrived speakers.

At fourth step t₄, the fourth segment \textcircled{4} is processed together with the context that includes the past segments 406 (which now includes the first segment, the second segment, and the third segment) and the current speaker-mapped cache 122. Embeddings of the fourth segment determined to be associated with Speaker 3 are added to the embeddings of that speaker previously stored in speaker-mapped cache 122. All new (non-silent) embeddings are added to the cache, and the speaker-mapped cache 122 is now filled up.

Subsequent updates of speaker-mapped cache 122 may include compressing speaker-mapped cache 122 using cache update function (CUF) 340.

More specifically, at fifth step t₅, the fifth segment \textcircled{5} is processed together with the context that includes the past segments 406 and the current speaker-mapped cache 122. As the size of the FIFO is 12 embeddings, the first embedding is now pushed out by the fourth segment entering the FIFO buffer. Embeddings of the fifth segment are determined to be associated with a new Speaker 4. Since the capacity of speaker-mapped cache 122 no longer supports storing all previous embeddings, the highest quality embeddings may be stored in speaker-mapped cache 122 from now on. As such, the fifth segment, the past segments 406, and the current speaker-mapped cache 122 are processed by diarization model 120 that outputs speaker activity likelihoods 460.

For example, CUF 340 may evaluate embeddings of the current (fifth) segment and embeddings stored in speaker-mapped cache 122 and may assign a quality score Sᵢ to each embedding. In some embodiments, the quality score may be computed as

$${S}_{i} = log {P}_{i} + {\sum }_{j \neq i} log ( 1 - {P}_{j} ) .$$

Accordingly, the computed quality scores favor embeddings (for a given speaker i) that have (1) the highest probability Pᵢ of speaker i speaking and (2) the highest probability 1−Pⱼ of other speakers j≠i being silent for a time interval of speech associated with a given embedding.

As illustrated with the non-limiting example of FIG. 5, equal number K=3 of highest-quality embeddings are allocated to each speaker. In some embodiments, a minimum number of embeddings Kₘᵢₙ may be allocated to individual speakers to prevent speakers from being crowded out from speaker-mapped cache 122 by higher-quality embeddings associated with other speakers (e.g., those who speak more clearly or are located closer to microphone(s)). The remaining space in speaker-mapped cache 122 may be allocated to a shared pool of high-confidence embeddings that are allocated based on quality scores independent of the speaker. For example, if speaker-mapped cache 122 has the total size L and the number of determined speakers is N, the number of embeddings Mₚₒₒₗ in the shared pool may be determined according to the formula,

$$L = N \cdot {K}_{min} + N \cdot Δ + {M}_{pool} ,$$

where Δ is the number of spacer embeddings detected to be associated with silence when no speaker is active, e.g., Δ=1, 2, etc. (Δ=1 in the example is illustrated in FIG. 5.) In this example, spacers are added N times, including after the last speaker's embeddings. This helps the model with distinguishing between different speakers.

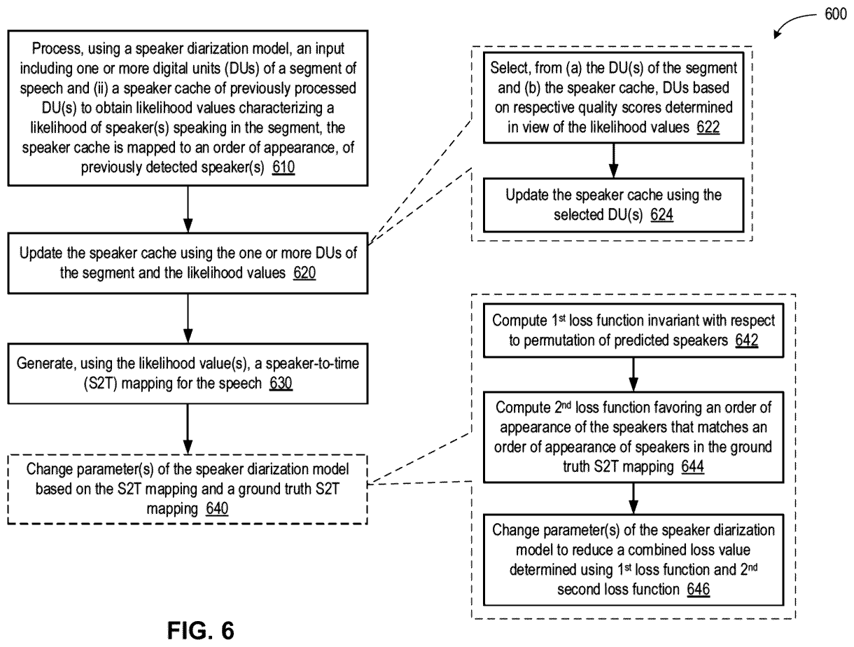

FIG. 6 is a flow diagram of an example method 600 of training and deployment of a streaming diarization model that performs efficient diarization of multi-speaker speech using speaker-mapped cache, according to at least one embodiment. Method 600 may be performed using one or more processing units (e.g., CPUs, GPUs, accelerators, PPUs, DPUs, etc.), which may include (or communicate with) one or more memory devices. In at least one embodiment, method 600 may be performed using processing units of audio processing server 102, training server 160 (with reference to FIG. 1), computing device 200 (with reference to FIG. 2), and/or other suitable computing systems. In at least one embodiment, processing units performing method 600 may be executing instructions stored on non-transitory computer-readable storage media. In at least one embodiment, method 600 may be performed using multiple processing threads (e.g., CPU threads and/or GPU threads), individual threads executing one or more individual functions, routines, subroutines, or operations of the method. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not always be performed.

Method 600 may involve speech utterances produced by people in any suitable context, e.g., a conversation, a public speech, a public event, a business meeting, a conference, a street encounter, an interaction in a game, an interaction with a chat bot or a digital avatar, an interaction with an in-vehicle infotainment system, and/or the like. “Speech,” as used in the context of method 600 should be understood as also including sounds of non-human origins, e.g., sounds of animals. “Speech,” as used in the context of method 600 should also be understood as including sounds produced by non-living entities, including natural forces, such as wind, sea, ocean, thunderstorms, and various other atmospheric or naval phenomena, as well as robotic speech, synthesized or computer-generated speech, and so on.

At block 610, method 600 may include processing, using a speaker diarization model, an input that includes (i) one or more digital units (DUs) of a segment of speech (e.g., current segment 404 in FIG. 4) and (ii) a speaker cache of one or more previously processed DUs of the speech (e.g., speaker-mapped cache 122 in FIG. 4 and FIG. 5) to obtain a plurality of likelihood values. Each likelihood value may characterize a likelihood that one or more speakers are speaking in the segment of the speech. The likelihood values may be probabilities Pᵢ, logarithms of probabilities, log Pᵢ, or some other suitable values, e.g., log[Pᵢ/(1−Pᵢ)], indicative of such likelihoods. The speaker cache may be mapped to the order of appearance, in the speech, of one or more previously detected speakers. For example, the order of appearance may be mapped to positions of the previously processed DUs in the speaker cache, with a speaker detected first being associated with position indexed with i=1, a speaker detected second being associated with position indexed with i=2, and so on. In training applications of method 600, the speaker diarization model may be a model that is initialized, partially trained and/or finetuned. In applications of method 600, the speaker diarization model may be a trained model whose training has been completed (but may be subject to additional future retraining or finetuning).

In some embodiments, an individual DU may be (or include) one or more spectrograms of the speech or an embedding generated by processing, using a pre-encoder network (e.g., pre-encoder subnetwork 410 in FIG. 4), one or more spectrograms of the speech. In some embodiments, the pre-encoder network may include one or more convolutional neuron layers. In some embodiments, the pre-encoder network may be a lightweight neural network. In some embodiments, the speaker diarization model may include one or more conformer blocks (e.g., fast conformer subnetwork(s) 430 in FIG. 4).

In some embodiments, the input into the speaker diarization model may include a predetermined number of DUs preceding the segment of the speech (e.g., past segment(s) 406 in FIG. 6). In some embodiments, the predetermined number of DUs preceding the segment of the speech may be stored in a first-in-first-out (FIFO) buffer. The FIFO buffer may be a hardware memory device (e.g., register) or may be implemented programmatically as a software buffer, e.g., a set of linked memory locations storing data that is sequentially moved between these locations in a FIFO fashion when new data is stored in the first memory location with the oldest stored data removed from the register.

The speaker cache may be mapped to the order of appearance of the one or more previously detected speakers using any suitable arrangement that is consistently used as an input into the speaker diarization model. In some embodiments, the speaker cache may be mapped to this order of appearance by sequential placement, in the speaker cache, of the one or more previously processed DUs of the speech in the order of appearance of the one or more previously detected speakers (e.g., as illustrated in FIG. 5 where embeddings associated with Speaker 1 are stored near an end of the speaker cache, embeddings associated with Speaker 2 are stored next, and so on).

In some embodiments, the speaker cache may include at least a minimum number (K) of DUs associated with each of the one or more previously detected speakers. In some embodiments, the speaker cache may further include one or more silent DUs associated with detected absence of speech activity. For example (e.g., as illustrated in FIG. 5), the speaker cache may include a plurality of contiguous sets of DUs (indicated with squares of similar shading in FIG. 5), each set associated with a respective speaker of the one or more previously detected speakers, and the contiguous sets interspersed with at least one silent DU of the one or more silent DUs (shown with white squares). In some embodiments, silent DUs may be identified as DUs for which speech activity associated with all identified speakers is below a silence threshold, P<P_{S}, e.g., P_{S}=0.1, 0.2, . . . , and/or some other empirical value.

At block 620, method 600 may include updating the speaker cache using the one or more DUs of the segment of the speech and the plurality of likelihood values. At least a subset of the plurality of likelihood values may be mapped to the positions of the previously processed DUs in the speaker cache. (Some of the likelihood values may correspond to newly detected speakers not yet represented in the speaker cache.) In some embodiments, operations of block 620 may include one or more operations indicated with the top callout portion of FIG. 6. More specifically, at block 622 updating the speaker cache may include selecting, from (a) the one or more DUs of the segment of the speech and (b) the speaker cache of the one or more previously processed DUs of the speech, one or more DUs based on respective quality scores (e.g., Sᵢ, as disclosed in conjunction with FIG. 5) determined in view of the plurality of likelihood values. For example, each quality score Sᵢ=−log P_{i-comb} may characterize a combined likelihood (a) that an individual speaker speaks at a time associated with an individual DU and (b) that one or more other speakers are silent at the time associated with the individual DU (e.g., P_{i-comb}=Pᵢ·Π_{j≠i}(1−Pⱼ), and/or the like). At block 624, method 600 may include updating, using the one or more selected DUs, the speaker cache, e.g., by maintaining previously stored DUs in the speaker cache, adding the one or more selected DUs to the speaker cache, replacing some of the stored DUs with the selected DU(s), and/or the like.

In some embodiments, updating the speaker cache may be performed as part of processing of each new segment of the speech. In other embodiments, updating the speaker cache may be performed following processing of a predetermined number of multiple segments of the speech, e.g., two, five, ten, or any other number of segments.

At block 630, method 600 may include generating, using the plurality of likelihood values, a speaker-to-time mapping for the speech. For example, one or more speakers may be selected for various individual units or times (e.g., timestamps, frames) of the speech based on the likelihood values computed for such units, e.g., by mapping one or more speakers to the units/times provided that the likelihood of the speakers speaking is at least equal to a threshold likelihood.

In those instances where method 600 is used to train the speaker diarization model, operations of the method may include, at block 640, changing one or more parameters of the speaker diarization model based on the S2T mapping generated for a training speech by the model and a ground truth S2T mapping for the training speech. In some embodiments, changing the one or more parameters of the speaker diarization model may include operations of the bottom callout portion of FIG. 6. More specifically, at block 642, method 600 may include computing, based on the S2T mapping and the ground truth S2T mapping, a first loss function invariant with respect to permutation of a plurality of predicted speakers in the S2T mapping (e.g., permutation-invariant loss function L_{PI}). At block 644, method 600 may continue with computing a second loss function (e.g., arrival-order loss function L_{AO}) favoring an order of appearance of the plurality of predicted speakers in the S2T mapping that matches an order of appearance of a plurality of ground truth speakers in the ground truth S2T mapping. At block 646, method 600 may include changing the one or more parameters of the speaker diarization model to reduce a combined loss value determined using the first loss function and the second loss function.

The disclosed embodiments may be illustrated with the following Examples. In Example 1, a method is illustrated that includes, for each of at least a subset of a plurality of segments of a training speech: processing, using a speaker diarization model, an input comprising: (i) one or more digital units (DUs) of a respective segment of the training speech and (ii) a speaker cache of one or more previously processed DUs of the training speech to obtain a set of likelihood values, each likelihood value of the set characterizing a likelihood of one or more speakers speaking in the respective segment of the training speech, wherein positions of the previously processed DUs in the speaker cache are mapped to an order of appearance, in the training speech, of one or more previously detected speakers. The method further includes updating the speaker cache using at least: the one or more DUs of the respective segment of the training speech, and the set of likelihood values, wherein at least a subset of the set of likelihood values is mapped to the positions of the previously processed DUs in the speaker cache. The method further includes generating, using the sets of likelihood values obtained for the subset of the plurality of segments of the training speech, a speaker-to-time mapping (S2T) for the training speech; and changing one or more parameters of the speaker diarization model based on the S2T mapping for the training speech and a ground truth S2T mapping for the training speech.

Example 2 illustrates the method of Example 1, wherein changing the one or more parameters of the speaker diarization model comprises: computing a first loss function based on the S2T mapping and the ground truth S2T mapping, wherein the first loss function is invariant with respect to permutation of a plurality of predicted speakers in the S2T mapping; computing a second loss function based on the training S2T mapping and the ground truth S2T mapping, wherein the second loss function favors an order of appearance of the plurality of predicted speakers in the S2T mapping that matches an order of appearance of a plurality of ground truth speakers in the ground truth S2T mapping; and changing the one or more parameters of the speaker diarization model to reduce a combined loss value determined using the first loss function and the second loss function.

Example 3 illustrates the method of Example 1, wherein the input further comprises a predetermined number of DUs preceding the respective segment of the training speech.

Example 4 illustrates the method of Example 1, wherein updating the speaker cache comprises: selecting, from (a) the one or more DUs of the respective segment of the training speech and (b) the speaker cache of the one or more previously processed DUs of the speech, one or more DUs based on respective quality scores determined in view of the set of likelihood values; and updating, using the one or more selected DUs, the speaker cache.

Example 5 illustrates the method of Example 4, wherein each quality score characterizes a combined likelihood (a) that an individual speaker speaks at a time associated with an individual DU and (b) that one or more other speakers are silent at the time associated with the individual DU.

Example 6 illustrates the method of Example 5, wherein the speaker cache is mapped to the order of appearance of the one or more previously detected speakers by sequential placement, in the speaker cache, of the one or more previously processed DUs of the speech in the order of appearance the one or more previously detected speakers, and wherein the speaker cache further comprises one or more silent DUs associated with detected absence of speech activity.

Example 7 illustrates a method of updating a speaker diarization model is illustrated that includes: providing a training speech episode and a corresponding ground truth mapping; arranging the ground truth mapping into a sequence of arrival-order labels where a first-arriving speaker is assigned a first index and one or more subsequent speakers are assigned a respective subsequent index in order of initial appearance in the training speech episode; and adjusting parameters of the speaker diarization model to minimize a loss function that penalizes deviations from the sequence of arrival-order labels.

Example 8 illustrates a method for updating a neural network for streaming diarization is illustrated that includes: processing a training audio signal comprising a plurality of digital units to generate predicted speaker likelihoods; and updating weights of the neural network based at least on a hybrid loss function comprising a weighted combination of: (i) a permutation-invariant loss component; and (ii) an arrival-order loss component that favors predicted speaker indices matching a chronological order of initial appearance of speakers in the training audio signal.

Example 9 illustrates the method of any one of Example 7 or Example 8, wherein the updating further includes: initially training the speaker diarization model as an offline model using a plurality of complete speech episodes; and subsequently fine-tuning the speaker diarization model using a simulated streaming environment that incorporates an arrival-order speaker cache.

Example 10 illustrates the method of any one of Example 7 or Example 8, wherein the updating further includes performing random permutation augmentation by randomly re-ordering speaker indices within a speaker cache during training steps for improving model robustness to varying arrival sequences.

Example 11 illustrates the method of any one of Example 7 or Example 8, wherein the adjusting or updating is performed while limiting a right-context of a self-attention mechanism in the speaker diarization model to less than 600 milliseconds of future audio context.

Example 12 illustrates the method of any one of Example 7 or Example 8, wherein the updating utilizes a cache update function that selects digital units for a speaker cache based at least on a probabilistic quality score, the probabilistic quality score characterizing a combined likelihood that a specific speaker is active and other speakers are silent.

Example 13 illustrates the method of Example 12, wherein the digital units are selected from the group consisting of: raw audio samples, time-domain waveforms, spectrograms, convolutional embeddings, and attention-based contextual tokens.

Example 14 illustrates the method of any one of Example 7 or Example 8, wherein the updating further includes: generating an average silence embedding from digital units where no speaker activity is detected; and inserting a plurality of the average silence embeddings as spacers between contiguous sets of speaker-specific digital units in a speaker cache to facilitate neural separation of speakers.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, analytics operations, factory operations, generation and/or presentation of augmented reality (AR), virtual reality (VR), mixed reality (MR), etc., robotics operations, medical operations, security and surveillance (e.g., in a smart cities embodiment), autonomous or semi-autonomous machine applications, deep learning, environment simulation, object or actor simulation and/or digital twinning, data center processing, generative AI operations, conversational AI operations, operations involving vision language models, large language models, small language models, multi-modal language models, light transport simulations (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), and in-vehicle infotainment system for an autonomous or semi-autonomous machine, systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, SLMs, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs) —which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs) —which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, SLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs) —which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

Although examples may be described herein with respect to using machine learning models, such as neural networks or language models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

### Inference and Training Logic

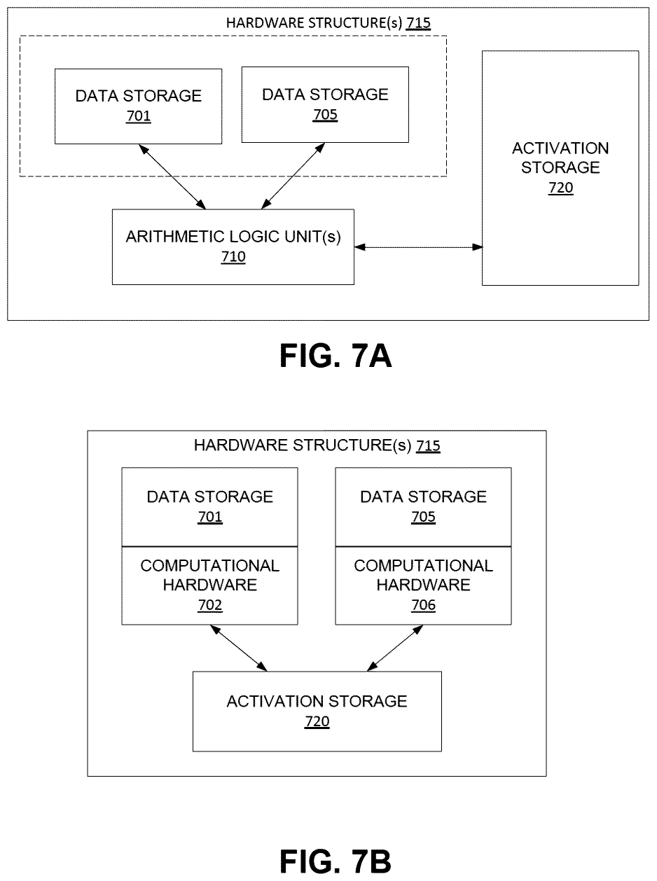

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a coprocessor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

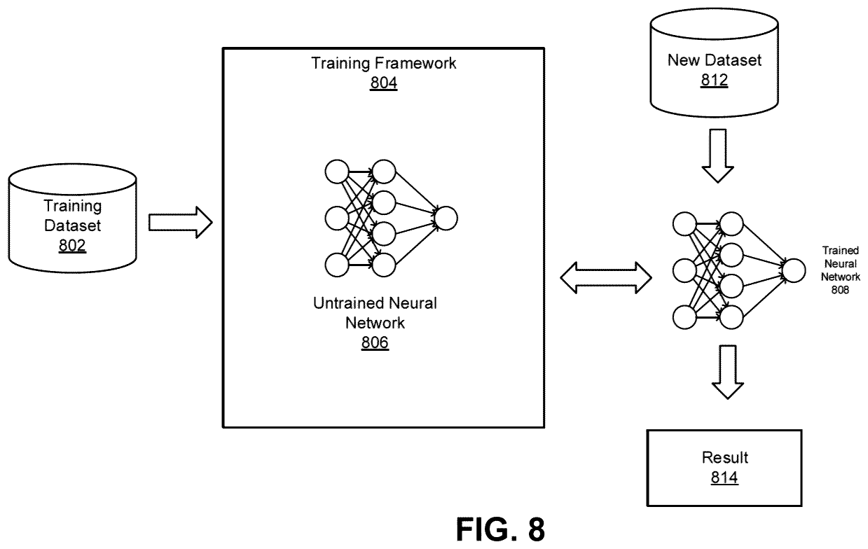

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

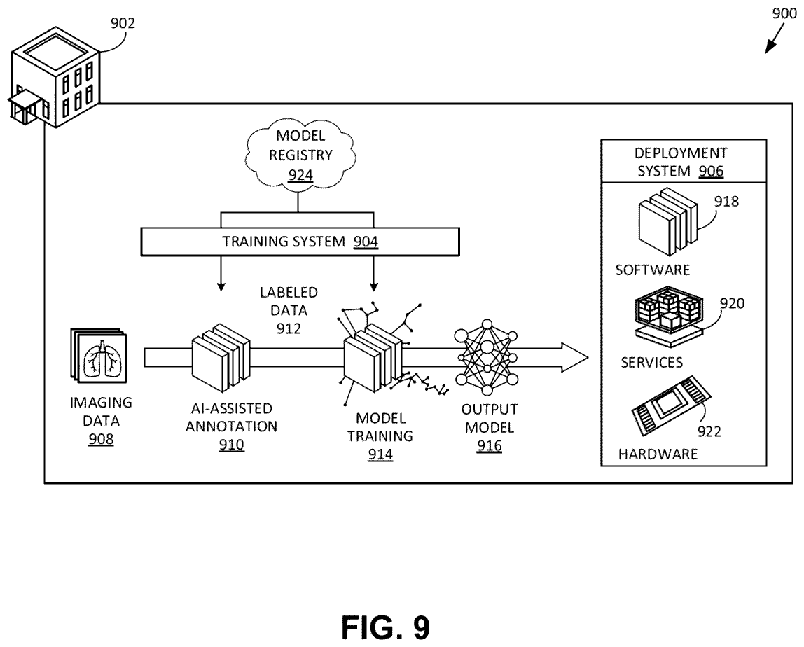

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

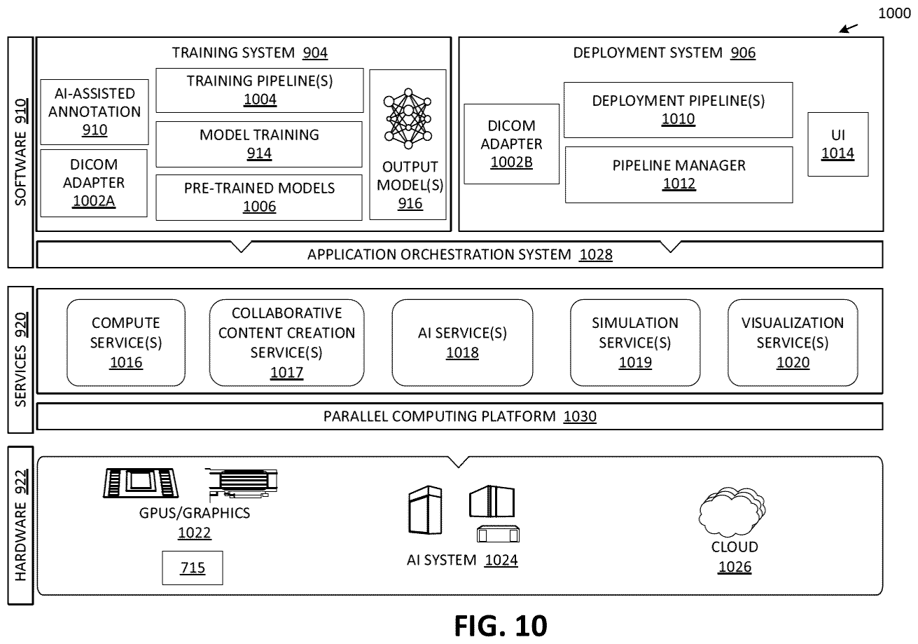

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of a data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high-performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may be implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904 and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) —such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s) and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc. —as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

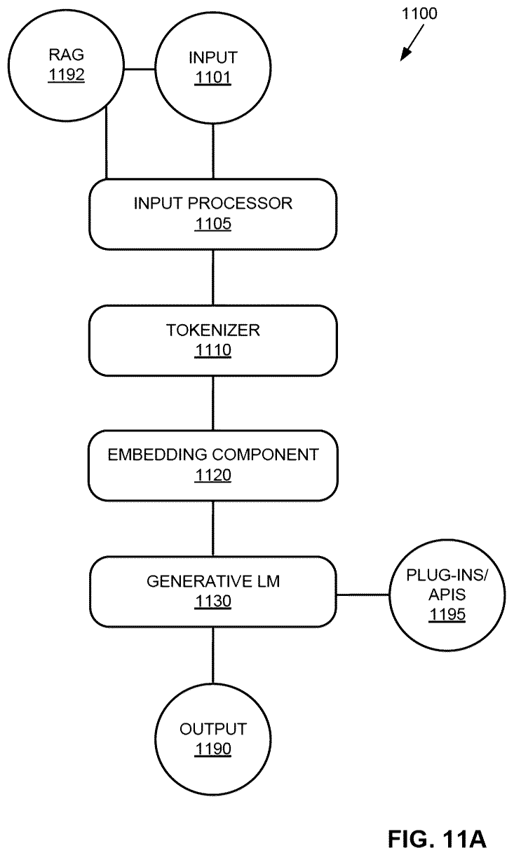

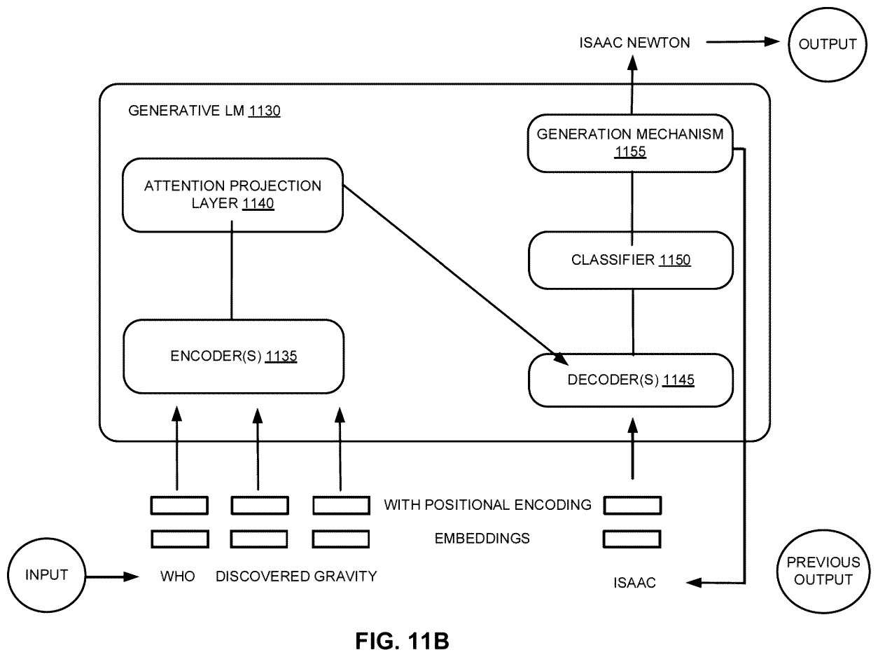

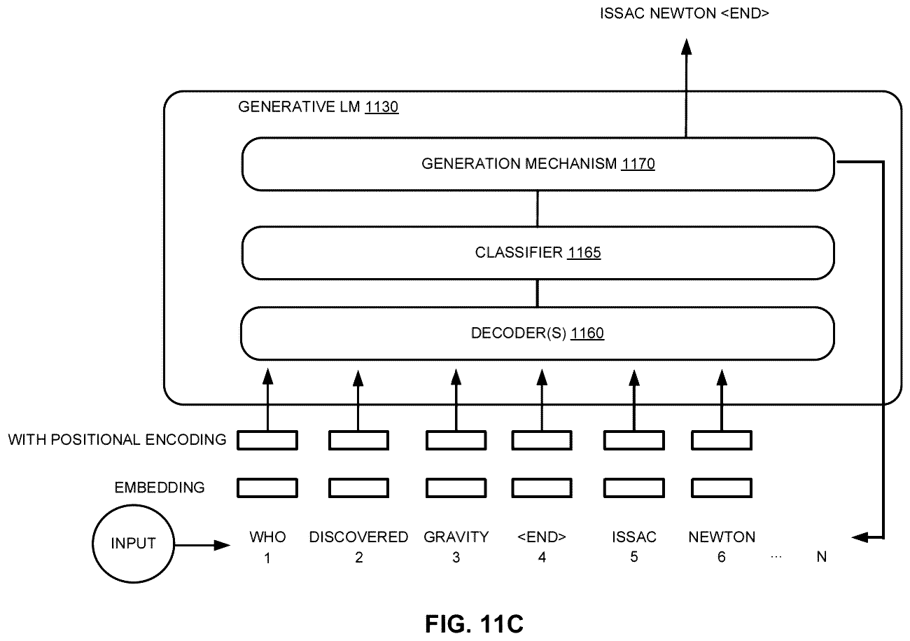

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc. —graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embedding models.

The tokenizer 1110 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to a tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example embodiment in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 11A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

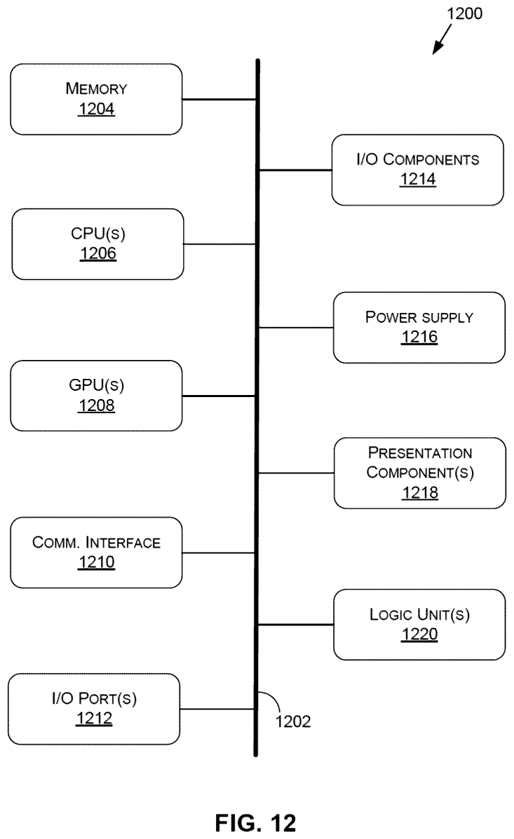

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) —which may include one or more direct memory access (DMA) systems, one or more vision or vector processing units (VPUs), one or more pixel processing engines (PPEs) —e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

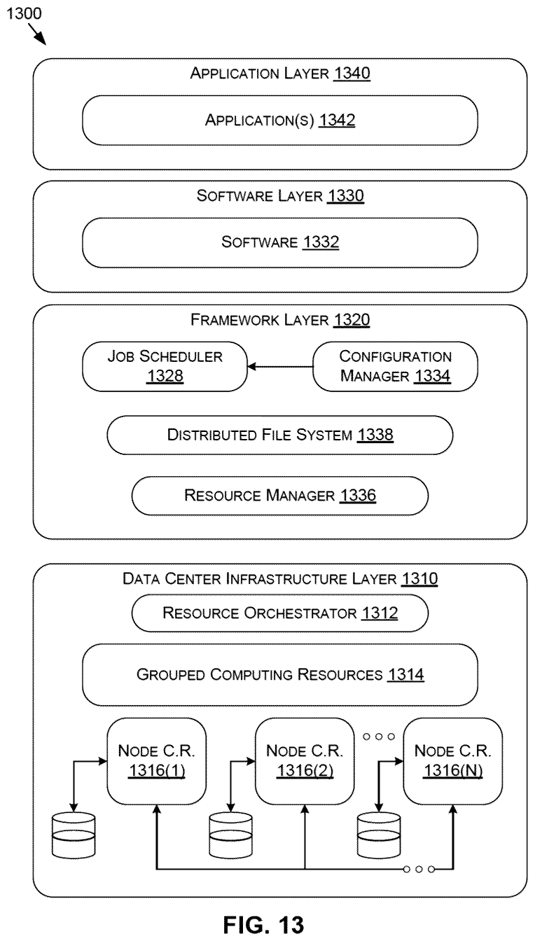

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

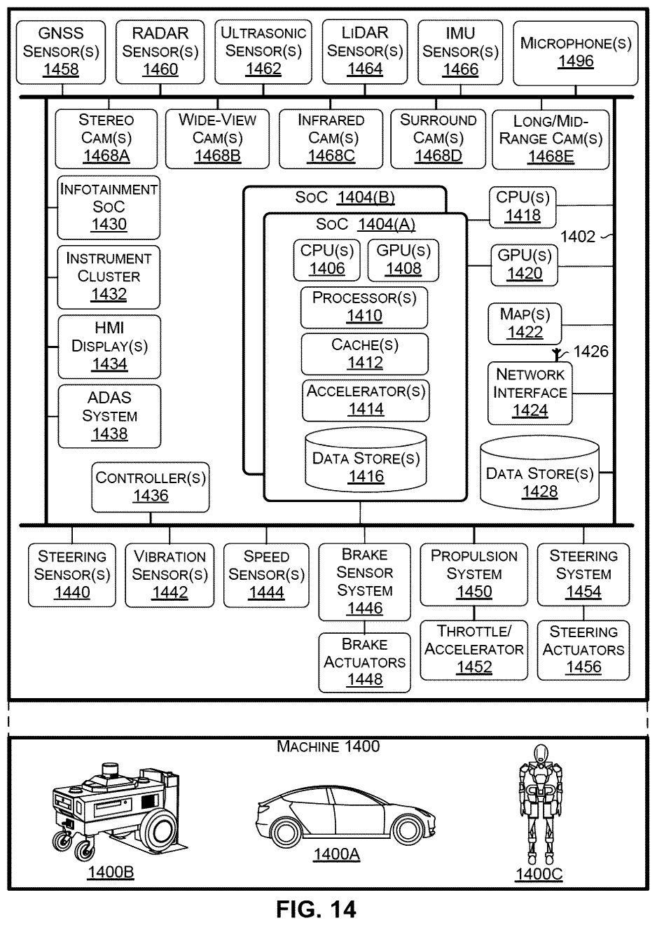

FIG. 14 is a block diagram of an example system architecture for a machine 1400, such as autonomous or semi-autonomous vehicle 1400A, autonomous mobile robot (AMR) 1400B, humanoid robot 1400C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), language processing units (LPUs), tensor streaming processors (TSPs), optical flow accelerators (OFAs), etc.), application-specific integrated circuits (ASICs), data processing units (DPUs), quantum processors, etc.) executing instructions stored in memory.

Each of the components, features, and systems of the machine 1400 in FIG. 14 are illustrated as being connected via bus 1402 (alternatively referred to as a “machine communications network 1402,” or just “communications network 1402”). The bus 1402 may include a Controller Area Network (CAN) data interface (alternatively referred to herein as a “CAN bus”). A CAN may be a network inside the machine 1400 used to aid in control of various features and functionality of the machine 1400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1402 may include FlexRay, an embedded bus (e.g., SPI, I2C), local interconnect link (LIN), NVIDIA's NVLink, ultra accelerator Link (UALink), USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1402, this is not intended to be limiting. For example, there may be any number of busses 1402, which may include one or more CAN busses, one or more FlexRay busses, one or more Ethernet busses, and/or one or more other types of busses using a different protocol. In some examples, two or more busses 1402 may be used to perform different functions, and/or may be used for redundancy. For example, a first bus 1402 may be used for collision avoidance functionality and a second bus 1402 may be used for actuation control. In any example, each bus 1402 may communicate with any of the components of the machine 1400, and two or more busses 1402 may communicate with the same components. In some examples, each SoC 1404, each controller 1436, and/or each computer or compute engine within the machine 1400 may have access to the same input data (e.g., inputs from sensors of the machine 1400), and may be connected to a common bus, such as a CAN bus.

The machine 1400 may include components such as a chassis, a vehicle body, wheels (e.g., 2, 4, 6, 8, 18, etc.), tires, axles, batteries, side-view mirrors, and/or other components of a vehicle or machine. The machine 1400 may include a propulsion system 1450, such as an internal combustion engine, hybrid electric power plant, an all-electric engine, a hydrogen-fueled engine, and/or another propulsion system type. The propulsion system 1450 may be connected to a drive train of the machine 1400, which may include a transmission, to enable the propulsion of the machine 1400. The propulsion system 1450 may be controlled in response to receiving signals from the throttle/accelerator 1452.

A steering system 1454, which may include a steering wheel and/or other steering device (e.g., remote steering and/or local steering), may be used to steer the machine 1400 (e.g., along a desired path or route) when the propulsion system 1450 is operating (e.g., when the vehicle is in motion). The steering system 1454 may receive signals from a steering actuator 1456. In some embodiments, a steering wheel or other steering mechanism may not be included, such as for a machine 1400 capable of full automation (e.g., Level 5) functionality.

The brake sensor system 1446 may be used to operate the vehicle brakes in response to receiving signals from the brake actuators 1448 and/or brake sensors.

The machine 1400 may include one or more controller(s) 1436. The controller(s) 1436 may be used for a variety of functions, and may be coupled to any of the various other components and systems of the machine 1400. For example, the controllers 1436 may be used for control of the machine 1400, artificial intelligence executing on the machine 1400, infotainment for the machine 1400, and/or the like. For example, one controller 1436 may be used for some or all of the functionality, or different controllers 1436 may be used for different functionalities—e.g., to ensure availability and a safety separation between various controllers for different tasks. For example, the controller(s) 1436 may use plans computed by the system—e.g., paths or trajectories for vehicles 1400A or AMRs 1400B, or movements, components trajectories, movement locations or displacements, etc. for joints or components (e.g., of manipulators, end effectors, limbs, hands, fingers, legs, feet, etc.), of a humanoid robot 1400C—to control the machine(s) 1400 in the environment. In some instances, the controller(s) 1436 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1400C, for example, the controller(s) 1436 may act as the brain, responsible for analyzing sensor data, making decisions, and sending commands to the actuators. The controller(s) 1436 may include a low-level controller that handles basic motor control, ensuring accurate and precise movements of individual joints and actuators. The controller(s) 1436 may include a high-level controller to coordinate multiple actuators and sensors, planning complex motions and adapting to changing environments.

The controller(s) 1436 may include an artificial intelligence controller, in embodiments, that may use AI algorithms (e.g., DNNs, MLMs, etc.) to learn, make decisions, and autonomously perform tasks for the machine 1400. In some embodiments, the controller(s) 1436 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1436 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1436, which may include one or more systems on chip (SoCs) 1404, CPUs, GPU(s), accelerator(s), etc., may provide signals (e.g., representative of commands or messages) to one or more components and/or systems of the machine 1400. Although the controller(s) 1436 is listed separately from the SoC(s) 1404, this is not intended to be limiting, and in some embodiments one or more components of the SoC(s) 1404 may perform the operations of the controller(s) 1436. For example, the controller(s) may send signals to operate the machine brakes via one or more brake actuators 1448, to operate the steering system 1454 via one or more steering actuators 1456, to operate the propulsion system 1450 via one or more throttle/accelerators 1452, etc. The controller(s) 1436 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1400. The controller(s) 1436 may include a first controller 1436 for autonomous control and navigation functions, a second controller 1436 for functional safety functions, a third controller 1436 for artificial intelligence functionality (e.g., computer vision), a fourth controller 1436 for infotainment functionality, a fifth controller 1436 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1436 may handle two or more of the above functionalities, two or more controllers 1436 may handle a single functionality, and/or any combination thereof.

The controller(s) 1436 may provide the signals for controlling one or more components and/or systems of the machine 1400 in response to sensor data received from one or more sensors (e.g., sensor inputs). The sensor data may be received from, for example and without limitation, global navigation satellite systems (“GNSS”) sensor(s) 1458 (e.g., Global Positioning System sensor(s)), RADAR sensor(s) 1460, ultrasonic sensor(s) 1462, LiDAR sensor(s) 1464, inertial measurement unit (IMU) sensor(s) 1466 (e.g., accelerometer(s), gyroscope(s), magnetic compass(es), magnetometer(s), etc.), microphone(s) 1496, camera(s) 1468 (e.g., stereo camera(s) 1468A, wide-view camera(s) 1468B (e.g., fisheye cameras), infrared camera(s) 1468C, surround camera(s) 1468D (e.g., 360 degree cameras), long-range and/or mid-range camera(s) 1468E, and/or other camera types), speed sensor(s) 1444 (e.g., for measuring the speed of the machine 1400), vibration sensor(s) 1442, steering sensor(s) 1440, brake sensor(s) (e.g., as part of the brake sensor system 1446), actuators, and/or other sensor types.

One or more of the controller(s) 1436 may receive inputs (e.g., represented by input data) from an instrument cluster 1432 of the machine 1400 and provide outputs (e.g., represented by output data, display data, etc.) via a human-machine interface (HMI) display 1434 (e.g., screen, heads-up display, mirror display, facial display, robotic display, etc.), an audible annunciator, a loudspeaker, a speaker, and/or via other components of the machine 1400. The outputs may include information such as machine velocity, speed, time, map data corresponding to a map(s) 1422 (e.g., from a navigation map, a Standard Definition (SD) map, a High Definition (“HD”) map, etc.), location data (e.g., the machine's 1400 location, such as on a map 1422), direction, location of other vehicles (e.g., an occupancy map, height map, bird's eye view (BEV) image, grid, etc.), information about objects and status of objects as perceived by the system, system status information, etc. For example, the HMI display(s) 1434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1400 may include one or more systems on a chip (SoCs) 1404. The SoC(s) 1404 may include CPU(s) 1406, GPU(s) 1408, processor(s) 1410, cache(s) 1412, accelerator(s) 1414, data store(s) 1416, and/or other components and features. The SoC(s) 1404 may be used to process and provide data for various operations, such as navigation, planning, reasoning, inference, perception, control, and/or actuation operations of the machine 1400 in a variety of platforms and systems. For example, the SoC(s) 1404 may process live perception data (e.g., from camera, LiDAR, RADAR, ultrasonic, etc.) in addition to map data corresponding to one or more maps 1422 (e.g., HD map, SD map, navigational map, occupancy map, etc.) in order to make or aid in performing various operations of the machine 1400. Where a map and/or AI is used, map and/or AI (e.g., model parameter updates, fine-tuning, etc.) refreshes and/or updates via a network interface 1424 from one or more servers (e.g., server(s) 1478) —such as one or more servers of a cloud-based data center.

Although an SoC(s) 1404 is illustrated in FIG. 14, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs) —without departing from the scope of the present disclosure. For example, depending on the type of machine 1400, use of the machine 1400, model of the machine 1400, and required capabilities of the machine 1400, one or more SoCs 1404 and/or alternative architectures and/or components may be used to satisfy the particular implementation.

The machine 1400 may include a CPU(s) 1418 (e.g., discrete CPU(s), or dCPU(s)), that may be coupled to the SoC(s) 1404 via a high-speed interconnect (e.g., PCIe). The CPU(s) 1418 may include an X86 processor, for example. The CPU(s) 1418 may be used to perform any of a variety of functions, including arbitrating potentially inconsistent results between ADAS sensors and the SoC(s) 1404, and/or monitoring the status and health of the controller(s) 1436 and/or infotainment SoC 1430, for example.

The machine 1400 may include a GPU(s) 1420 (e.g., discrete GPU(s), or dGPU(s)), that may be coupled to the SoC(s) 1404 via a high-speed interconnect (e.g., NVIDIA's NVLink, ultra accelerator Link (UALink), etc.). The GPU(s) 1420 may provide additional artificial intelligence functionality, such as by executing redundant and/or different neural networks, and may be used to train and/or update neural networks based on input (e.g., sensor data) from sensors of the machine 1400.

The machine 1400 may further include the network interface 1424 which may include one or more wireless antennas 1426 and/or modems (e.g., one or more wireless antennas for different communication protocols, such as a cellular antenna, a Bluetooth antenna, etc.). The network interface 1424 may be used to enable wireless connectivity over the Internet with the cloud (e.g., with the server(s) 1478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1400 information about vehicles in proximity to the machine 1400 (e.g., vehicles in front of, on the side of, and/or behind the machine 1400). This functionality may be part of a cooperative adaptive cruise control functionality of the machine 1400.

The network interface 1424 may include a SoC that provides modulation and demodulation functionality and enables the controller(s) 1436 to communicate over wireless networks. The network interface 1424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1400 may further include data store(s) 1428 which may include off-chip (e.g., off the SoC(s) 1404) storage. The data store(s) 1428 may include one or more storage elements including RAM, SRAM, DRAM, VRAM, Flash, hard disks, and/or other components and/or devices that may store at least one bit of data.

The machine 1400 may further include GNSS sensor(s) 1458. The GNSS sensor(s) 1458 (e.g., GPS, assisted GPS sensors, differential GPS (DGPS) sensors, etc.), to assist in mapping, perception, occupancy grid generation, and/or path planning functions. Any number of GNSS sensor(s) 1458 may be used, including, for example and without limitation, a GPS using a USB connector with an Ethernet to Serial (RS-232) bridge.

The machine 1400 may further include IMU sensor(s) 1466. The IMU sensor(s) 1466 may be located at a center of the rear axle of the machine 1400, in some examples. The IMU sensor(s) 1466 may include, for example and without limitation, an accelerometer(s), a magnetometer(s), a gyroscope(s), a magnetic compass(es), and/or other sensor types. In some examples, such as in six-axis applications, the IMU sensor(s) 1466 may include accelerometers and gyroscopes, while in nine-axis applications, the IMU sensor(s) 1466 may include accelerometers, gyroscopes, and magnetometers.

In some embodiments, the IMU sensor(s) 1466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1466 may enable the machine 1400 to estimate heading without requiring input from a magnetic sensor by directly observing and correlating the changes in velocity from GPS to the IMU sensor(s) 1466. In some examples, the IMU sensor(s) 1466 and the GNSS sensor(s) 1458 may be combined in a single integrated unit.

The vehicle may include one or more microphone 1496 placed in and/or around the machine 1400. The microphone(s) 1496 may be used for emergency vehicle detection and identification, among other things.

The machine 1400 may further include vibration sensor(s) 1442. The vibration sensor(s) 1442 may measure vibrations of components of the machine, such as the arms or legs of a humanoid robot 1400C, or the axle(s) of a vehicle 1400A or AMR 1400B. For example, changes in vibrations may indicate a change in road, walking, or traversable surfaces. In another example, when two or more vibration sensors 1442 are used, the differences between the vibrations may be used to determine friction or slippage of the surface (e.g., when the difference in vibration is between a power-driven axle and a freely rotating axle).

The machine 1400 may include an ADAS system 1438—such as when the machine 1400 is a vehicle 1400A. The ADAS system 1438 may include a dedicated SoC(s), in some examples. The ADAS system 1438 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1400 may further include the infotainment SoC 1430 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1400. For example, the infotainment SoC 1430 may radios, disk players, navigation systems, video players, USB and Bluetooth connectivity, carputers, in-car entertainment, Wi-Fi, steering wheel audio controls, hands free voice control, a heads-up display (HUD), an HMI display 1434, a telematics device, a control panel (e.g., for controlling and/or interacting with various components, features, and/or systems), and/or other components. The infotainment SoC 1430 may further be used to provide information (e.g., visual and/or audible) to a user(s) of the vehicle, such as information from the ADAS system 1438, autonomous driving information such as planned vehicle maneuvers, trajectories, surrounding environment information (e.g., intersection information, vehicle information, road information, etc.), and/or other information.

The infotainment SoC 1430 may include GPU functionality. The infotainment SoC 1430 may communicate over the bus 1402 (e.g., CAN bus, Ethernet, etc.) with other devices, systems, and/or components of the machine 1400. In some examples, the infotainment SoC 1430 may be coupled to a supervisory MCU such that the GPU of the infotainment system may perform some self-driving functions in the event that the primary controller(s) 1436 (e.g., the primary and/or backup computers of the machine 1400) fail. In such an example, the infotainment SoC 1430 may put the machine 1400 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), language reasoning models (LRMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1400—whether a vehicle 1400A, AMR 1400B, humanoid robot 1400C, and/or other type of machine—may include a locally stored language model(s) and/or communicate to a remotely hosted language model (e.g., via one or more APIs) to provide more detailed and in-depth communication features to the users of the machine(s) 1400.

In some examples, an infotainment SoC 1430, the SoC(s) 1404, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1400. The always on sensor processing engine may be used to unlock the vehicle when the owner approaches the driver door and turn on the lights, and, in security mode, to disable the vehicle when the owner leaves the vehicle. In this way, the SoC(s) 1404 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, LRMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1400.

The machine 1400 may further include an instrument cluster 1432 (e.g., a digital dash, an electronic instrument cluster, a digital instrument panel, etc.). The instrument cluster 1432 may include a controller and/or supercomputer (e.g., a discrete controller or supercomputer). The instrument cluster 1432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1430 and the instrument cluster 1432. In other words, the instrument cluster 1432 may be included as part of the infotainment SoC 1430, or vice versa.

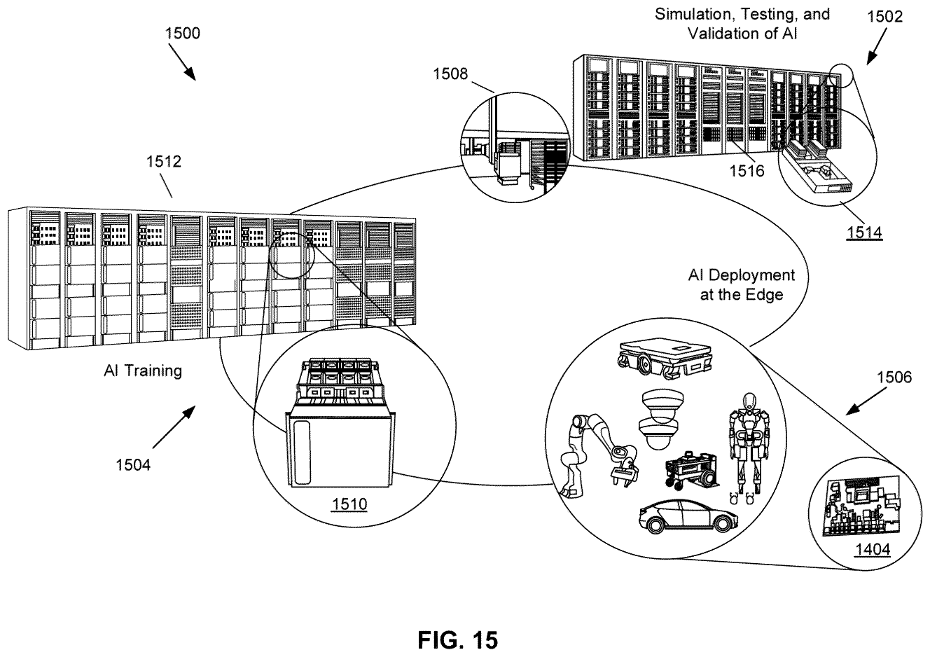

FIG. 15 is a system diagram illustrating a three computer ecosystem 1500, including a first computing system 1502 for generating or creating artificial intelligence (AI) —such as AI training and validation data, a second computing system 1504 for training artificial intelligence, and a third computing system 1506 (which may include or correspond to the SoC(s) 1404 of FIG. 14) deploying the AI at the edge, in accordance with at least some embodiments of the present disclosure. For example, to develop and deploy embodied or physical AI, the three computer ecosystem 1500 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1400 and their worlds. By doing so, simulation of machine(s) 1400 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 1400 can perform safely in controlled settings.

The computing system 1504 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 1400 to understand natural language and emulate movements by observing human actions. The computing system 1504 may include a platform that incorporates software, infrastructure, and expertise in a modern, unified AI development and training solution. The computing system 1504 may include individual computing devices 1510 (e.g., NVIDIA's DGX B200, H200, etc.) and/or any number of computing devices 1510 in a data center infrastructure 1512 (e.g., NVIDIA's DGX SuperPOD).

For example, the individual computing devices 1510 may include GPUs (e.g., 8 GPUS with 1,440 GB total GPU memory) and CPUs (e.g., 2 CPUs with 112 cores total, 2.1 GHZ, or 4 GHz (with boost)) that provide upwards of 72 petaFLOPS for training and 144 petaFLOPS for inference. The computing devices 1510 may include memory (e.g., 4 TB memory, and storage (e.g., OS storage of 2×1.9 TB NVMe M.2, and internal storage of 8×3.84 TB NVMe U.2). The computing devices 1510 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1510 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 1510 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1510 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1510 may include a smart host channel adapter (HCA) (e.g., NVIDIA's ConnectX-7) to provide ultra-low latency, 400 Gb/s throughput for in-network computing acceleration engines.

The data center infrastructure 1512 may include any number of the computing devices 1510, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1510) to thousands, job scheduling and orchestration to ensure hassle-free execution of every developer's job, AI workflow management and machine learning operations (MLOps) to move more models from prototype to production, and enterprise software to speed developer success.

The computing system 1502 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1502 allows developers to use simulation frameworks to simulate and validate robot models, and/or to generate massive amounts of physically-based synthetic data to bootstrap model training. The computing system 1502 may support learning frameworks that power robot reinforcement learning and imitation learning, to accelerate robot policy training and refinement. For example, the computing system 1502 may be used to generate any number of simulations 1508—such as within NVIDIA's OMNIVERSE. The computing system 1502 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1502 may host or support a native OpenUSD software platform enabling enterprises to connect 3D pipelines and develop advanced, real-time 3D applications for industrial digitalization. With powerful ray-tracing-accelerated AI and graphics capabilities, the computing system 1502 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1502 may include individual computing devices 1514 (e.g., NVIDIA's OVX L40S Server) and/or any number of computing devices 1514 in a data center infrastructure 1516 (e.g., NVIDIA's OVX Systems).

The computing device(s) 1514 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 1514 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 1514 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1514 may include a smart host channel adapter (HCA) (e.g., NVIDIA's ConnectX-7) to provide ultra-low latency, 400 Gb/s throughput for in-network computing acceleration engines. The computing device(s) 1514 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 1512, the data center infrastructure 1516 may allow for any number of computing device(s) 1514 to be combined in cluster configuration according to a reference architecture.

The computing system 1506 may be used to deploy trained AI models on a runtime computer—such as the SoC(s) 1404 described herein. For example, these computing systems 1506 may be designed for compact, on-board computing needs, including an ensemble of models for control policy, vision and language models, etc., deployed on a power-efficient on-board edge computing system 1506.

The disclosure may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some embodiments, process of obtaining, acquiring, receiving, or inputting analog or digital data may be accomplished by transferring data via a serial or parallel interface. In another embodiment, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example embodiments of described techniques, other architectures may be used to implement described functionality and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using a trained speaker diarization model, an input comprising (i) one or more digital units (DUs) of a segment of speech and (ii) a speaker cache of one or more previously processed DUs of the speech to obtain a plurality of likelihood values, each likelihood value characterizing a likelihood of one or more speakers speaking in the segment of the speech, wherein positions of the previously processed DUs in the speaker cache are mapped to an order of appearance, in the speech, of one or more previously detected speakers;
updating the speaker cache using at least:
the one or more DUs of the segment of the speech, and
the plurality of likelihood values, wherein at least a subset of the plurality of likelihood values is mapped to the positions of the previously processed DUs in the speaker cache, and
generating, using the plurality of likelihood values, a speaker-to-time mapping for the speech.

2. The method of claim 1, wherein an individual DU comprises at least one of:
one or more spectrograms of the speech, or
an embedding generated by processing, using a pre-encoder network, the one or more spectrograms of the speech.

3. The method of claim 2, wherein the pre-encoder network comprises one or more convolutional neuron layers.

4. The method of claim 1, wherein the trained speaker diarization model comprises one or more conformer blocks.

5. The method of claim 1, wherein the input further comprises a predetermined number of DUs preceding the segment of the speech.

6. The method of claim 5, wherein the predetermined number of DUs preceding the segment of the speech is stored in a first-in-first-out (FIFO) buffer.

7. The method of claim 1, wherein updating the speaker cache comprises:
selecting, from (a) the one or more DUs of the segment of the speech and (b) the speaker cache of the one or more previously processed DUs of the speech, one or more DUs based on respective quality scores determined in view of the plurality of likelihood values; and
updating, using the one or more selected DUs, the speaker cache.

8. The method of claim 7, wherein each quality score characterizes a combined likelihood (a) that an individual speaker speaks at a time associated with an individual DU and (b) that one or more other speakers are silent at the time associated with the individual DU.

9. The method of claim 1, wherein the speaker cache is mapped to the order of appearance of the one or more previously detected speakers by sequential placement, in the speaker cache, of the one or more previously processed DUs of the speech in the order of appearance of the one or more previously detected speakers.

10. The method of claim 1, wherein the speaker cache comprises at least a minimum number of DUs associated with each of the one or more previously detected speakers.

11. The method of claim 1, wherein the speaker cache further comprises one or more silent DUs associated with detected absence of speech activity.

12. The method of claim 11, wherein the speaker cache comprises a plurality of contiguous sets of DUs, each set associated with a respective speaker of the one or more previously detected speakers, the contiguous sets interspersed with at least one silent DU of the one or more silent DUs.

13. A method for updating a neural network for streaming diarization, comprising:
providing a training speech episode and a corresponding ground truth mapping;
arranging the ground truth mapping into a sequence of arrival-order labels where a first-arriving speaker is assigned a first index and one or more subsequent speakers are assigned a respective subsequent index in order of initial appearance in the training speech episode; and
adjusting parameters of the speaker diarization model to minimize a loss function that penalizes deviations from the sequence of arrival-order labels.

14. The method of claim 13, further comprising:
initially training the speaker diarization model as an offline model using a plurality of complete speech episodes; and
subsequently fine-tuning the speaker diarization model using a simulated streaming environment that incorporates an arrival-order speaker cache.

15. The method of claim 13, wherein the updating further comprises performing random permutation augmentation by randomly re-ordering speaker indices within a speaker cache during training steps for improving model robustness to varying arrival sequences.

16. The method of claim 13, wherein the adjusting is performed while limiting a right-context of a self-attention mechanism in the speaker diarization model to less than 600 milliseconds of future audio context.

17. The method of claim 13, wherein the adjusting utilizes a cache update function that selects digital units for a speaker cache based at least on a probabilistic quality score, the probabilistic quality score characterizing a combined likelihood that a specific speaker is active and other speakers are silent.

18. The method of claim 13, further comprising:
generating an average silence embedding from digital units where no speaker activity is detected; and
inserting a plurality of the average silence embeddings as spacers between contiguous sets of speaker-specific digital units in a speaker cache to facilitate neural separation of speakers.

19. A system comprising:
one or more processors to:
process, using a trained speaker diarization model, an input comprising (i) one or more digital units (DUs) of a segment of speech and (ii) a speaker cache of one or more previously processed DUs of the speech to obtain a plurality of likelihood values, each likelihood value characterizing a likelihood of one or more speakers speaking in the segment of the speech, wherein the speaker cache is mapped to an order of appearance, in the speech, of one or more previously detected speakers;
update the speaker cache using at least:
the one or more DUs of the segment of the speech, and
the plurality of likelihood values; and
generate, using the plurality of likelihood values, a speaker-to-time mapping for the speech.

20. The system of claim 19, wherein the system is comprised in at least one of an in-vehicle infotainment system for an autonomous or semi-autonomous machine;
a system for performing one or more simulation operations;
a system for performing one or more digital twin operations;
a system for performing light transport simulation;
a system for performing medical operations;
a system for performing factory operations;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more small language models (SLMs);
a system implementing one or more vision language models (VLMs);
a system implementing one or more multi-modal language models (MMLMs);
a system implementing one or more vision-language-action (VLA) models;
a system implemented using an inference microservice that includes an operating-system (OS) level virtualization package and one or more machine learning models;
a system for performing one or more generative AI operations;
a system for generating synthetic data;
a system incorporating one or more virtual machines (VMs);
a system implemented at least partially in a data center; or
a system implemented at least partially using cloud computing resources.
